(19) United States
(12) Patent Application Publication
(10) Pub. No.: US 2012/0298222 A1
(43) Pub. Date: Nov. 29, 2012

(54) FLOW CONTROL VALVE

(75) Inventors: Avraham Zakay, Zichron Yaakov (IL); Ehud Nagler, Kiryat Tivon (IL); Oded Elish, Kryat Tivon (IL); Hagay Weisbrod, Jordan Valley (IL)

(73) Assignee: S.P.C. TECH LTD., Jordan Valley (IL)

(21) Appl. No.: 13/503,746

(22) PCT Filed: Oct. 28, 2010
(86) PCT No.: PCT/IL2010/000892

§ 371 Date: Aug. 9, 2012

Related U.S. Application Data
(60) Provisional application No. 61/279,998, filed on Oct. 29, 2009.

(51) Int. Cl. F16K 31/00

(52) U.S. Cl. 137/505.12

(57) ABSTRACT

Provided is a two-stage valve including a housing fitted with an inlet port extending to an inlet chamber and configured for coupling to an upstream liquid supply line, and an outlet port extending from an outlet chamber and configured for coupling to a downstream supply line; a high flow-rate path extending between the inlet chamber and the outlet chamber fitted with a hydraulic element configured for selectively admitting liquid flow therebetween at a demand position defined by substantially high flow; and a pressure regulating unit configured for controlling a pressure regulating flow path providing direct or indirect flow communication between the inlet chamber and the outlet chamber for allowing liquid flow therebetween at a leak position defined by substantially low flow rates.

### FIELD OF THE INVENTION

The present disclosed subject matter is concerned with a flow control valve. More particularly the disclosed subject matter is concerned with a self regulated two-stage flow control valve.

### BACKGROUND OF THE INVENTION

It is not un-common for buildings, either domestic or public structures, office buildings, factories and the like, that leaks occur at the water supply pipes or at plumbing fixtures such as faucets, toilets, irrigation equipment and the like. Such liquid supply pipes and plumbing fixtures are typically fed with pressurized liquid (depending for example on municipal supply pressure, elevation, etc.) and are hereinafter in the specification and claims are referred to collectively as ‘downstream consumers’.

A leak, by nature, is referred to as an undesired flow of liquid, at a substantially low flow rate, through a downstream consumer, and usually deliver relatively small amounts of liquid.

However, a dreadful scenario is an event of a burst of a liquid supply pipe or a pipe coupling or any other downstream consumer. A burst is defined as an undesired flow of liquid delivering liquid at a substantially high flow rate.

Leaks and bursts, either detected at an early stage or after a while, may cause large scale damage to the structure (floor, ceiling, walls), to carpets and parquets, furniture, electric, electronic, telecommunication and computer equipment, personal belongings etc. This is considered as one of the major losses for insurance companies. Evenmore so, where fresh water supply is problematic (e.g. at remote locations or where fresh water is not found), a significant burst (long-lasting and at substantially high flow rate), this may result in temporary shortage of water supply.

Municipalities or any other water (liquid) suppliers, will supply the water at a pressure sufficient to reach the most remote and elevated consumers. Thus, many consumers are supplied with water at high pressure, significantly higher than that in fact required for their location. Yet, at certain hours of the day consumption is very low (e.g. at night), whilst at other hours consumption reaches a peak, requires that water be supplied to meet peak time pressure requirements.

### SUMMARY OF THE INVENTION

According to the present disclosed subject matter there is provided a spontaneous, self regulated two-stage flow control valve, and a method employing same.

The valve is configured such that to provide the following effects:
A. At no consumption—i.e. there is no demand of liquid downstream of the valve (manually by individuals or by automated liquid supply systems) and there are substantially no bursts at a downstream consumer. At this state the valve is configured to reduce downstream pressure (i.e. lower than an upstream, supply pressure, wherein Pₒᵤₜ<Pᵢₙ) and thus reduce the likelihood of leaks or bursts to take place.
B. At consumption—the valve is configured to allow substantially high flow rate, wherein Pₒᵤₜ≅Pᵢₙ.
Leak prevention/reducing—the valve reduces downstream pressure by generating a low pressure, thus reducing the flow rate through a leaking unit's, and preventing deteriorating of the leak into a burst.
Burst prevention/reducing—reducing the downstream pressure reduces the likelihood for bursts to occur.

A two-stage valve according to the present disclosed subject matter comprises an inlet port for coupling to an upstream liquid supply line, a high flow rate hydraulic faucet in flow communication with the inlet port, a low flow rate pressure regulating unit being in flow communication with the high flow rate hydraulic faucet and with an outlet port for coupling to a downstream supply line.

The valve is configured for spontaneous, self control of the outlet pressure (measured at the outlet port), responsive to fluid flow and flow demand patterns.

According to the presently disclosed subject matter two-stage valve comprises a housing fitted with an inlet port extending to an inlet chamber and configured for coupling to an upstream liquid supply line, and an outlet port extending from an outlet chamber and configured for coupling to a downstream supply line; a high flow-rate path extending between the inlet chamber and the outlet chamber fitted with a hydraulic element configured for selectively admitting liquid flow therebetween at a demand position defined by substantially high flow; a pressure regulating unit configured for controlling a pressure regulating flow path providing direct or indirect flow communication between the inlet chamber and the outlet chamber for allowing liquid flow therebetween at a leak position defined by substantially low flow rates.

Hereinafter in the specification and claims, the following symbols are used:

Pᵢₙ—designates the pressure at the inlet port and respective inlet chamber of the valve;

Pₒᵤₜ—designates the pressure at the outlet port and respective outlet chamber of the valve;

P_{mc}—designates the pressure at the main chamber: and

P_{cc}—designates the pressure at the control chamber.

The arrangement is such that at initial state of the valve (‘fully closed state’), upon closing all downstream consumers, the hydraulic faucet seals the high flow rate path (extending between the inlet chamber and the outlet chamber) and the pressure regulating flow path is sealed too, wherein momentarily Pₒᵤₜ≅Pᵢₙ≅P_{mc}≅P_{cc}.

Gradually, as a leak takes place at the downstream consumers (‘leak position’), the pressure Pₒᵤₜ slowly drops (Pₒᵤₜ<Pᵢₙ), as well as the pressure supporting the control diaphragm, giving rise to displacement of the control plunger to facilitate fluid flow at a low flow rate from the inlet chamber, via the bleed aperture at the main diaphragm, into main chamber, through the pressure regulating flow path and out through the outlet chamber and outlet port to the downstream consumers.

When high flow rate is in demand by the downstream consumers (‘demand position’), e.g. opening a tap or the like, the pressure at the main chamber droops (Pₒᵤₜ<P_{mc}<Pₘ) resulting deformation of the main diaphragm to open the high flow rate path facilitating high flow-rate flow between the inlet and outlet of the valve, and wherein the pressure regulating flow path is widely open (Pₒᵤₜ=P_{mc}<Pᵢₙ). When the downstream consumers stop the demand of liquid the system returns to the initial state of the valve, as discussed hereinabove.

A restricting arrangement is provided, to restrict axial displacement of the control plunger in order to ensure that the pressure regulating flow path opens to facilitate high flow rate thereabout and thus to prevent ‘fluctuations’ through the system. Namely, when the high flow-rate path opens, the pressure increases whereby the low flow-rate pressure regulating unit (which is configured for handling substantially low flow rates) tends to close and thus the control plunger displaces axially in direction to close the pressure regulating flow path, whereupon the high flow-rate path would close. For that reason it is desired to restrict axial displacement of the control plunger. It is appreciated that in pressure equilibriums illustrated herein, the force of the biasing spring is taken into consideration in addition to surface area ratios at both surfaces of the diaphragm, respectively.

Any one or more of the following features and configurations may be embodied in a valve and valve system according to the present disclosed subject matter:
The two-stage valve comprises a housing fitted with an inlet port extending to an inlet chamber and configured for coupling to an upstream liquid supply line, and an outlet port extending from an outlet chamber and configured for coupling to a downstream supply line; a high flow-rate path extending between the inlet chamber and the outlet chamber fitted with a hydraulic element configured for selectively admitting liquid flow therebetween at a demand position defined by substantially high flow; a pressure regulating unit configured for controlling a pressure regulating flow path providing direct or indirect flow communication between the inlet chamber and the outlet chamber for allowing liquid flow therebetween at a leak position defined by substantially low flow rates;
The valve futher comprises a mechanism for opening said high flow-rate path upon a demand for liquid downstream.
The high flow-rate path fitted with a hydraulic faucet comprising a main diaphragm extending between the inlet chamber and the outlet chamber configured for selectively admitting said liquid flow therebetween at substantially high flow rates.
The valve further comprises a main chamber extending at one face of the main diaphragm and configured with a restricted flow path extending between an inlet chamber and the main chamber.
The pressure regulating unit is further configured for mechanically releasing pressure from said main chamber at said high flow rates.
The pressure regulating unit is further configured for hydraulically releasing pressure from said main chamber at said high flow rates.
The valve further comprises a pressure releasing mechanism separated from said pressure regulating unit and configured for mechanically releasing pressure from said main chamber at said high flow rates.
The valve further comprises a pressure releasing mechanism separated from said pressure regulating unit and configured for hydraulically releasing pressure from said main chamber at said high flow rates.
The pressure regulating unit is configured with a control chamber fitted with a control diaphragm having one face in normally open flow communication with the outlet chamber and at an opposite face thereof is vented to the atmosphere.
The pressure regulating unit is configured with a control plunger, wherein said control diaphragm and control plunger are configured for controlling a pressure regulating flow path, and extends in flow communication between the main chamber and the outlet chamber.
The hydraulic faucet and the low flow-rate pressure regulating unit are integrated in a uniform housing, said hydraulic faucet and low flow-rate pressure regulating unit extending coaxially on top or below one another, at one side of the housing or at two sides thereof, or at a side-by-side configuration
The pressure regulating flow path is configured with an annular sealing portion fitted at the main diaphragm and a control plunger comprising a flow control end with a respective sealing head for sealing engagement of the annular sealing portion.
The low flow-rate pressure regulating unit extends coaxially to hydraulic faucet, wherein a control plunger of the pressure regulating unit extends through the outlet chamber and displaces towards sealing of the pressure regulating flow path in direction against the sealing direction of the main diaphragm.
The low flow-rate pressure regulating unit extends coaxially to hydraulic faucet, wherein a control plunger of the pressure regulating unit extends through the main chamber and further through said annular sealing portion fitted at the main diaphragm, and displaces towards sealing of the pressure regulating flow path in direction against the sealing direction of the main diaphragm.
The pressure regulating flow path is governed by displacement of a control plunger of the pressure regulating unit, whilst the main diaphragm does not play a role in governing of the pressure regulating flow path.
The main diaphragm is spring biased into sealing engagement of the high flow rate path and the control plunger being spring biased in direction to allow flow through the pressure regulating flow path.
The main diaphragm is configured with an annular sealing portion, wherein the annular sealing portion is configured for press sealing against an annular sealing shoulder defining the high flow-rate flow path.
The main diaphragm's annular sealing portion is provided with a cylindrical sealing extension configured for sealing engagement with a corresponding cylindrical seat of the high flow-rate path.
The pressure release is performed by restricting member configured to restrict axial displacement of a control plunger of the pressure regulating unit, at an open state of the high flow-rate path.
The hydraulic pressure release is performed by an intermediate chamber with an intermediary diaphragm having one side in flow communication with the inlet chamber and another side in flow communication with the main chamber; and wherein said intermediary diaphragm is articulated with the control plunger of the pressure regulating unit such that pressure differential over the intermediary diaphragm entails corresponding displacement of the control plunger.
The main diaphragm is formed with one or more apertures extending opposite said annular sealing shoulder, such that at a fully closed position and at the leak position said one or more apertures remain sealingly engaged by the annular sealing shoulder, and at the demand position of the system, as the diaphragm begins to deform into its open position, the one or more apertures disengage from their sealing engagement with the annular sealing shoulder, thus increasing further deformation.
The apertures are disposed about a circle coextending with the said annular sealing shoulder open upon even a minor displacement of the main diaphragm, thereby assisting in reaching pressure equilibrium between the main chamber and the outlet chamber, to thereby get the system into stabilization.
A hydraulic pressure release unit is provided between the main chamber and the outlet chamber, for selectively equalizing pressure between the main chamber and the outlet chamber.
The hydraulic unit is a hydraulic faucet configured with a release diaphragm, being in flow communication with the inlet chamber and configured for selective controlling fluid flow between the main chamber and the control chamber of the low flow-rate pressure regulating unit which in turn is in flow communication with the outlet chamber or directly between the main chamber and outlet chamber.
The low flow-rate pressure regulating unit is disposed offset the hydraulic faucet with the regulating flow path extending coaxial with said low flow-rate pressure regulating unit, wherein a flow path extends between the main chamber and one face of the sealing head of a control plunger of the pressure regulating unit, a flow path extends between the control chamber and an outlet camber, where the control plunger extends through an intermediate chamber with an intermediary diaphragm thereof having one side in flow communication with the inlet chamber and another side in flow communication with the main chamber and having articulated thereto a plunger seat being coaxially displaceable responsive to pressure differential over said intermediary diaphragm.
A high pressure regulating mechanism is provided, comprises of a dynamic restricting plunger and a coiled spring, which regulates outlet pressure during high flow rates by adjusting displacement of the control plunger of the pressure regulating unit so as to limit the opening of the common pressure regulating and pressure release flow path during demand position;
A low-pressure regulating valve and an electric faucet extending in parallel flow relation to one another, each having an inlet being in flow communication with the inlet port and outlet being in flow communication with the outlet port; and a flow sensor extending upstream of said outlet port or else extending downstream of said inlet port and configured for generating a flow control signal responsive to fluid flow and transmitting said signal to said electric faucet;
The high flow rate through the flow sensor results in generating a control signal to open the electric faucet and low flow rate through flow sensor entails shutting said electric faucet and resulting in directing low flow through the low-pressure regulating valve;
A restricting member is provided to restrict axial displacement of the control plunger at an open state of the pressure regulating flow path;
A pressure reducer valve may be fitted, in line before or after the two-stage valve, for setting the outlet pressure to a predetermined substantially fixed pressure. Such a pressure reducer valve provides constant downstream pressure, regardless of the upstream pressure and regardless of flow rate through the valve;
The restricting mechanism operates by restricting axial displacement of the control plunger, wherein the main diaphragm continues to displace into its open position, whereby pressure at the main chamber and the outlet chamber substantially equalizes (Pₒᵤₜ=P_{mc)}, resulting in a minor head loss owing to the biasing effect of the main diaphragm biasing spring;
It is appreciated that at demand position there exists a head-loss between the inlet pressure and the outlet pressure (typically between about 0.2-0.4 atm.). Such head-loss is considered as a minor loss.

According to another aspect of the presently disclosed subject matter there is provided a two-stage valve comprises a housing fitted with an inlet port extending to an inlet chamber and configured for coupling to an upstream liquid supply line, and an outlet port extending from an outlet chamber and configured for coupling to a downstream supply line; a high flow-rate path fitted with a hydraulic faucet comprising a main diaphragm extending between the inlet chamber and the outlet chamber for selectively admitting liquid flow therebetween at substantially high flow rates; a main chamber extending at one face of the main diaphragm and configured with a restricted flow path extending between an inlet chamber and the main chamber; a low flow-rate pressure regulating unit being in flow communication with the outlet chamber and configured with a control chamber fitted with a control diaphragm having one face in normally open flow communication with the outlet chamber and at an opposite face thereof is vented to the atmosphere; said control diaphragm is configured for controlling a pressure regulating flow path, and extends in flow communication between the main chamber and the outlet chamber.

According to another aspect of the present disclosed subject matter there is provided a two stage flow control valve comprising an inlet port and an outlet port, a low-pressure regulating valve and an electric faucet extending in parallel flow relation to one another, each having an inlet being in flow communication with the inlet port and outlet being in flow communication with the outlet port; and a flow sensor extending upstream of said outlet port or else extending downstream of said inlet port and configured for generating a flow control signal responsive to fluid flow and transmitting said signal to said electric faucet.

The high flow rate through the flow sensor results in generating a control signal to open the electric faucet and low flow rate through flow sensor entails shutting said electric faucet and resulting in directing low flow through the low-pressure regulating valve.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a longitudinal section through a two-stage flow control valve in accordance with the disclosed subject matter;

FIGS. 2A to 2D are longitudinal sections illustrating different flow states of the valve of FIG. 1;

FIGS. 3A to 3C illustrate a two-stage valve in accordance with a different configuration of the disclosed subject matter, at different flow states thereof;

FIG. 4A is a longitudinal section through a different example of a valve in accordance with the present disclosed subject matter;

FIG. 4B is a top, planar view of a main diaphragm used in the valve of FIGS. 4 and 5;

FIGS. 5A to 5C are longitudinal sections of the valve illustrated in FIG. 4A, at different flow conditions thereof;

FIGS. 5A′ to 5C′ are enlargements of portions identified in FIGS. 5A-5C, respectively;

FIGS. 6A and 6B illustrate two respective flow states of a valve in accordance with yet another example of the valve subject of the present disclosed subject matter;

FIGS. 7A and 7B are respective flow states of a valve in accordance with another example of the present disclosed subject matter;

FIGS. 8A to 8C are longitudinal sections illustrating different flow states of a valve in accordance with an example of the present disclosed subject matter;

FIGS. 9A to 9E are longitudinal sections illustrating different flow states of a valve in accordance with an example of the present disclosed subject matter;

FIGS. 10A to 10D are schematic representations of longitudinal sections through valves in accordance with different configurations in accordance with the disclosed subject matter;

FIG. 11A is a schematic longitudinal section of a valve in accordance with another example of the present disclosed subject matter;

FIGS. 11B to 11F are schematic representations illustrating different flow states of the valve illustrated in FIG. 11A;

FIG. 12A is a longitudinal section through a valve in accordance with yet another example of the present disclosed subject matter;

FIGS. 12B to 12D are longitudinal sections of the valve of FIG. 12A illustrating different flow states thereof;

FIGS. 13A to 13E are longitudinal sections through a valve in accordance with still an example of the present disclosed subject matter at different flow states thereof; and

FIGS. 14A to 14E are a block diagram schematically illustrating a control valve system in accordance with yet an example of the present disclosed subject matter.

### DETAILED DESCRIPTION OF EMBODIMENTS

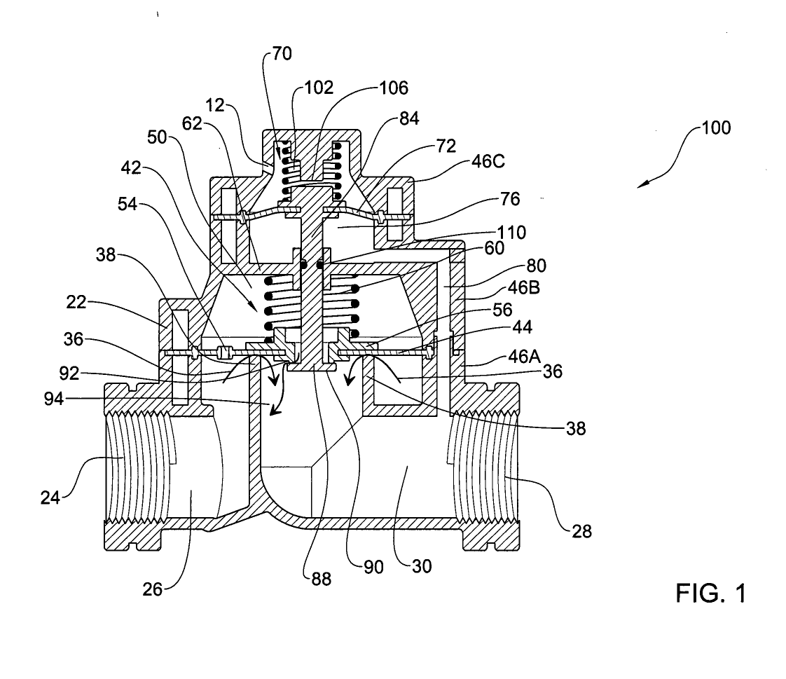

Turning first to FIG. 1 of the drawings there is illustrated a two-stage valve generally designated 100 comprising a housing 22 configured with an inlet port 24 configured for coupling to an upstream liquid supply line (not shown) and extending into an inlet chamber 26, an outlet port 28 configured for coupling to a downstream supply line (not shown) and extending from an outlet chamber 30. The downstream supply line may be a single consumer or a plurality of consumers adjacent or remote from the valve 100 and collectively referred to hereinafter in the specification and claims as downstream consumers.

It is noted that the inlet port 24 and the outlet port 28 are configured with internal threading for coupling to appropriate piping (not shown) however this being one of different possible coupling solutions.

The valve 100 is a globe-type valve and comprises a high flow-rate flow path represented by arrowed lines 36, extending over an annular sealing shoulder 38 extending from the outlet chamber 30. The high flow-rate flow path 36 is configured with an hydraulic faucet 42 comprising a main diaphragm 44 clampingly secured between a bottom housing portion 46A and top housing portion 46B.

The main diaphragm 44 rests over the annular sealing shoulder 38 in a sealing fashion defining above it a main chamber 50 which is in flow communication with the inlet chamber 26 via a bleed aperture 54 formed on the main diaphragm 44.

The main diaphragm 44 is fitted with a rigidified annular sealing portion 56 supported over a central aperture over the main diaphragm 44 and radially projecting, slightly beyond the annular high flow-rate path 36, said rigidified annular sealing portion being in the present case integrated with the main diaphragm 44 though in accordance with a different configuration (not shown) it may be integrally manufactured therewith.

A faucet coiled spring 60 bears at its lower end against a top surface of the rigidified annular sealing portion 56 and at its upper end against a bottom face of a partition wall 62 extending within the housing, said coiled spring 60 imparting the main diaphragm 44 with a biasing effect such that it normally sealingly engages the high flow-rate flow path 36 thus retains it at the so-called closed position at its normal state, as will be discussed hereinafter in further detail.

Further received within the housing 22 there is a low flow-rate pressure regulating unit generally designated 70 comprising a control diaphragm 72 clampingly secured within the top housing member 46B and a top cover portion 46C, thus defining a control chamber 76 extending below said control diaphragm 72 and being in fluid flow communication with outlet chamber 30 via a duct 80, normally open such that a pressure equilibrium extends between the control chamber 76 and the outlet chamber 30. The control diaphragm 72 is articulated with a control plunger 84 configured with a sealing head 88 at its lower end with a top face thereof 90 sealingly engaging an annular downwardly projecting sealing shoulder 92 of the rigidified annular sealing portion 56 defining together a pressure regulating flow path represented by arrowed line 94, and which in FIG. 1 is illustrated at the closed position.

As can further be seen in FIG. 1, the control diaphragm 72 has its top face exposed to atmospheric pressure via a venting aperture 12 fitted at the top cover portion 46C and further there is provided a coiled spring 102, bearing at its bottom end against a top portion of the control plunger 84 and a top end of the coiled spring 102 bearing against a top portion of the top cover portion 46C, thereby biasing the control plunger 84 into a normally downward position.

As can further be seen, the top cover portion 46C is fitted with a restricting projection 106 downwardly projecting, and configured for restricting upward displacement of the control plunger 84, as will be discussed hereinafter.

Further noticed there is provided a O-ring 110 over the control plunger 84, for facilitating axial displacement of the plunger 84 within the partition wall 62, however providing adequate sealing between the main chamber 50 and the control chamber 76.

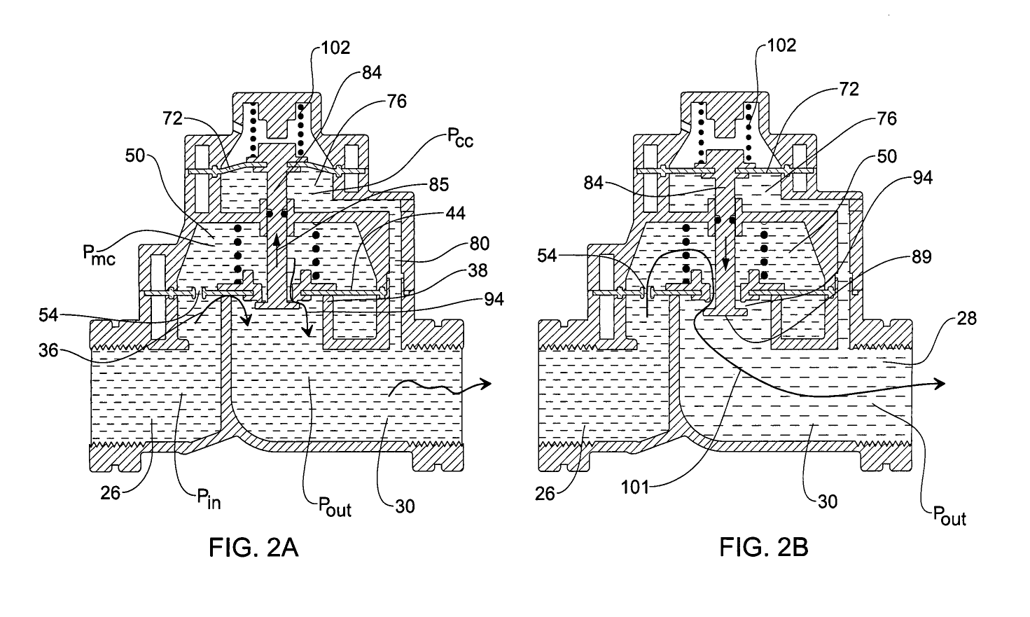

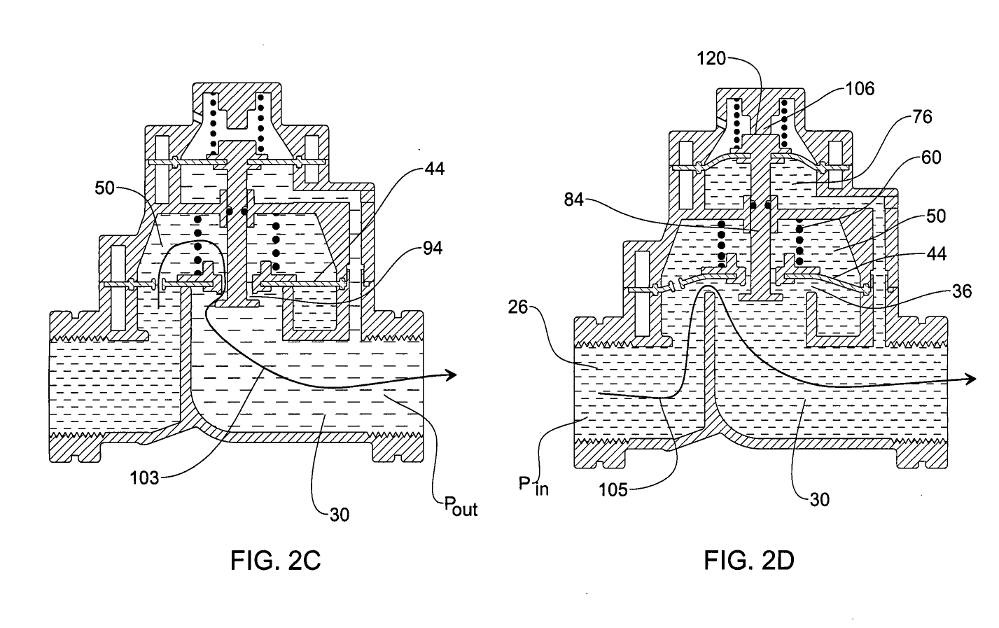

Further attention is now directed to FIGS. 2A-2E exemplifying the different flow conditions and operation of the valve disclosed in connection with FIG. 1 and the general principles of a two-stage valve in accordance with the disclosed subject matter.

FIG. 2A illustrates the valve at an initial state thereof namely a fully-closed state promptly upon closing all downstream consumers. As can be seen, at this state the high flow-rate flow path 36 is sealingly closed by virtue of the main diaphragm 44 sealingly bearing over the annular sealing shoulder 38. Likewise, the pressure regulating flow path 94 is closed by virtue of top face 90 of the control plunger 84 sealingly bearing against the sealing shoulder 92. The main diaphragm 44 is configured for press sealingly against the annular sealing shoulder 38.

In this situation all chambers and passages of the valve extend at the same pressure namely the pressure Pᵢₙ at the inlet chamber 26 extends also at the main chamber 50 (pressure designated P_{mc}) and at the outlet chamber 30 Pₒᵤₜ and at the control chamber 76 P_{cc}, owing to pressure equalizing through the bleed aperture 54 extending between the inlet chamber 26 and the main chamber 50 and via duct 80 extending between the outlet chamber 30 and the control chamber 76.

However, the state illustrated in FIG. 2A is a momentarily and occurs upon the sudden shutdown of the downstream consumers causing a momentarily increase at the outlet chamber 30 and corresponding at the control chamber 76 being at constant flow communication with one another through duct 80.

The effective cross sectional area acting at the bottom side of the main diaphragm 44 from both its faces is substantially equal and the coiled spring 60 thus provides the force for displacing the main diaphragm 44 and maintaining it at the closed position.

The pressure regulating flow path 94 remains sealed by virtue of the high pressure residing within the control chamber 76, resulting in deformation of the control diaphragm 72 to bulge upwardly, entailing axial displacement of the control plunger 84 in an upward direction of arrow 85.

It is an assumption that owing to pressure at the pipe system at the downstream consumers, leaks, even minor by nature, take place constantly. As a result of such leaks, the pressure Pₒᵤₜ at the outlet chamber 30 slightly drops, entailing corresponding change in pressure at the control chamber 76, as a result of which the control diaphragm 72 is biased into its normal position (FIG. 2B) under influence of the coiled spring 102, resulting in axial downward displacement of the control plunger 84 whereupon the pressure regulating flow path 94 opens, facilitating slow flow-rate fluid flow from the inlet chamber 26, via the lead aperture 54, through the main chamber 50 and then out through the outlet port 28 to the downstream consumers (not shown) as represented by the arrowed line 101.

At this position, the pressure/force equilibrium acting on the control plunger 84 consists of the pressure extending at the outlet chamber and acting on the bottom face 89 of the plunger and the pressure extending at the main chamber 50 and acting on the top face 90 of the plunger head 88, and the force applied by the control spring 102 and the pressure extending at the control chamber 76 and acting on control diaphragm, which in turn acting on the control plunger 84.

In addition, it is noted that the cross sectional area of the bleed aperture 54 is significantly smaller than the maximal opening of the pressure regulating flow path 94.

In the illustration of FIG. 2B Pᵢₙ=P_{mc} and Pₒᵤₜ=P_{cc}.

Turning now to FIG. 2C, there is illustrated a situation upon opening a tap or the like at the downstream consumers, namely a position where there is demand for liquid downstream, referred to as a “demand position”.

At this position, the pressure Pₒᵤₜ at the outlet chamber 30 drops even further, resulting in further decrease of P_{mc} at the main chamber 50 resulting in turn in increased fluid flow through the pressure regulating flow path 94 as illustrated by the arrowed line 103 (FIG. 2C) wherein Pₒᵤₜ<P_{mc}<Pᵢₙ.

This situation occurs since, even though the fluid flow through the pressure regulating flow path 94 is equal to the fluid flow through the bleed aperture 54, there is significant head/pressure loss at the bleed aperture 54 caused by the increased flow velocity through bleed aperture 54, resulting in control chamber pressure drop, therefore a decreased hydraulic force extending on the upper side of the main diaphragm, further resulting in deformation of the main diaphragm 44 upwards, into the position illustrated in FIG. 2D whereby the hydraulic faucet 36 now opens to facilitate high flow rate through the high flow-rate path 36 as illustrated by arrowed line 105 to supply flow rate pair demand of the downstream consumer. At this position the inlet pressure Pᵢₙ at the inlet chamber 26 is higher than the pressure at the main chamber 50 and at the outlet chamber 30, resulting in deformation of the main diaphragm 44 to an open position, against the biasing effect of the coiled spring 60, wherein the pressure at the main chamber 50 is equal to the pressure at the outlet chamber 50 and at the control chamber 76 (P_{mc}=Pₒᵤₜ=P_{cc}).

As can be seen in FIG. 2D, a top surface 120 of the control plunger 84 engages a restricting projection 106 of the housing, thus preventing further axial displacement of the control plunger 84 in the upwards direction, to thereby maintain equal pressure at the main chamber 50 and at the outlet chamber 30, namely P_{mc}=Pₒᵤₜ and further to prevent a conflict condition, namely hammering of the valve resulting in oscillating of the main diaphragm 40 which may enter the valve into an unstable condition.

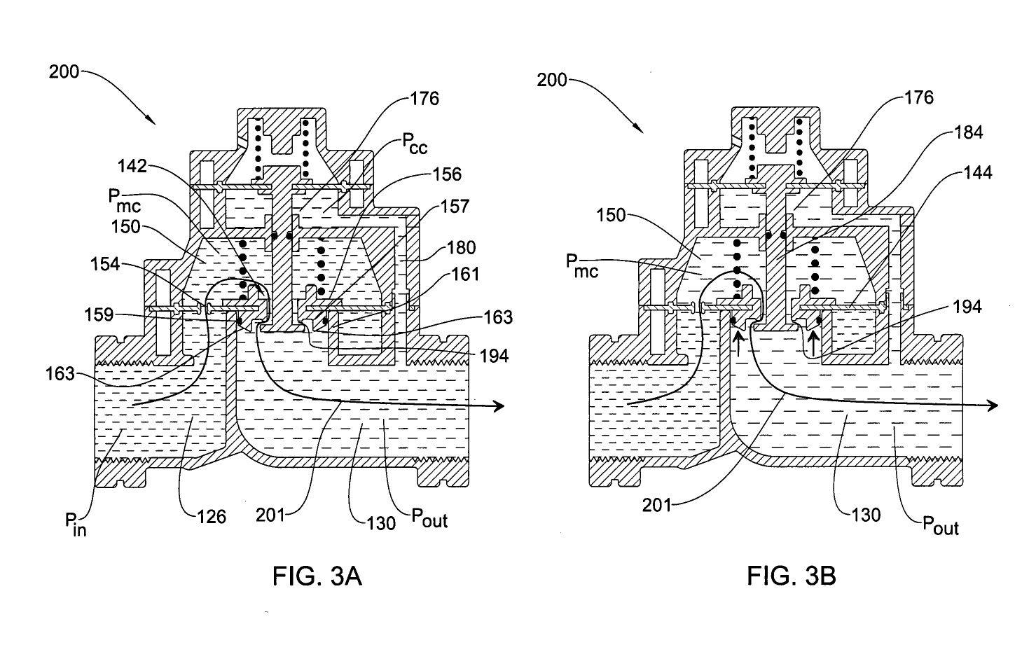

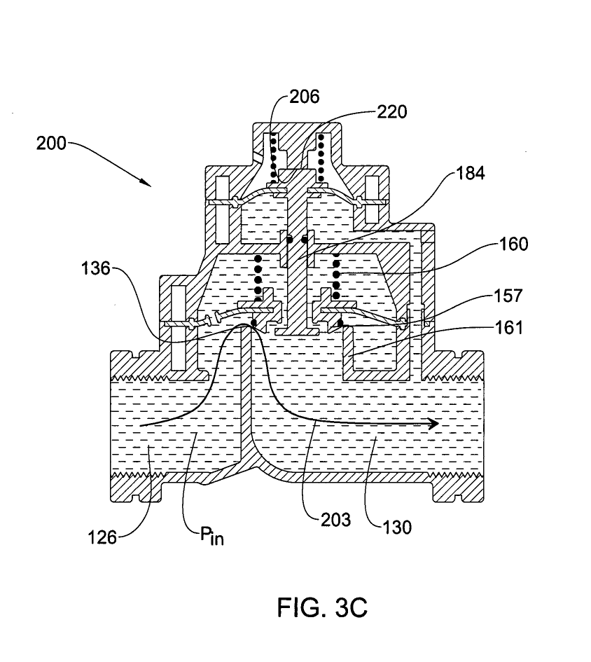

In FIGS. 3A to 3C there is illustrated a valve in accordance with a modification of the example illustrated in FIGS. 1 and 2, generally designated 200 and wherein like elements are designated with like reference numbers, however shifted by 100.

In the example of FIGS. 1 and 2, the main diaphragm 44 is configured for sealing engagement over the annular rigidified annular sealing member 38, supported from above by the rigidified annular sealing member 56.

However, in the example of FIGS. 3A to 3C, the rigidified annular sealing member 156 with a downwardly extending tubular extension 157 fitted with an O-ring (or any radial sealing member) 159 and configured for sealing engagement against the inner tubular-wall section 161 of the hydraulic faucet 142 constituting the high flow-rate flow path.

It is further noted that the downward extension 157 is configured with a chamfered edge 163 to facilitate smooth engagement of the tubular section upon displacement back into the sealing position, as will be discussed hereinafter.

In FIG. 3A the valve is illustrated at a leak position, namely a low flow-rate flow extends downstream, resulting in pressure decrease at the outlet chamber 130 wherein the pressure at the outlet chamber is substantially equal to the pressure at the control chamber 176 (Pₒᵤₜ=P_{cc}), as a result of the open flow duct 180 extending therebetween. However the pressure Pᵢₙ at the inlet chamber 126 is significantly higher, and at this stage substantially equal to the pressure P_{mc} at the main chamber 150, whereby a low flow-rate flow takes place as illustrated by arrowed line 201 from the inlet chamber 126, through the bleed aperture 154 into the main chamber 150 and then through the regulating flow path at 194 into the outlet chamber 130 and towards the downstream consumers. At this state, the annular portion 157 sealingly resides within the tubular portion 161, wherein the high flow-rate path is closed.

Upon demand, as a downstream consumer now for example opens a tap, the pressure Pₒᵤₜ at the outlet chamber 130 rapidly drops (with corresponding pressure decrease at the control chamber 176), however resulting in deformation of the main diaphragm 144 in an upwards direction, thus increasing the opening of the pressure regulating flow path 194 (the control plunger 184 at this stage still remains substantially at its position, wherein the cross sectional area of the flow path 194 increases owing to deformation of the main diaphragm 144, facilitating increased fluid flow as designated by arrowed line 201. At this position, the pressure at the main chamber 150 is substantially equal to the pressure at the outlet chamber 130, namely P_{mc}=Pₒᵤₜ=P_{cc}.

However, the pressure at the inlet chamber 126 is significantly higher than the pressure at the main chamber 150 and as the downstream consumer further demands fluid flow, the pressure applied at the bottom surface of the main diaphragm 144 (Pᵢₙ) will overcome the biasing effect of the main coiled spring 160 and pressure applied at the top of main diaphragm, resulting in disengagement of the annular sealing portion 157 from the tubular wall 161, giving rise to opening of the high flow-rate flow path 136, facilitating high flow-rate flow as illustrated by the arrowed line 203.

The configuration illustrated in FIGS. 3A to 3C however provides a somewhat extended intermediate stage of leak by prolonging the required axial displacement required for opening the flow path (in fact axial displacement and time required for the tubular sealing portion 157 to disengage from the annular wall 161, is extended), thus increasing stability of the system, namely the likelihood of hammering as discussed hereinabove.

It is noted that at the opened position, as in FIG. 3C, a top end 220 of the control plunger 184 engages a restricting surface 206 of the housing, thus preventing further upward displacement of the control plunger 184.

Closing the hydraulic faucet takes place as discussed hereinabove, in connection with the example of FIGS. 2A to 2D.

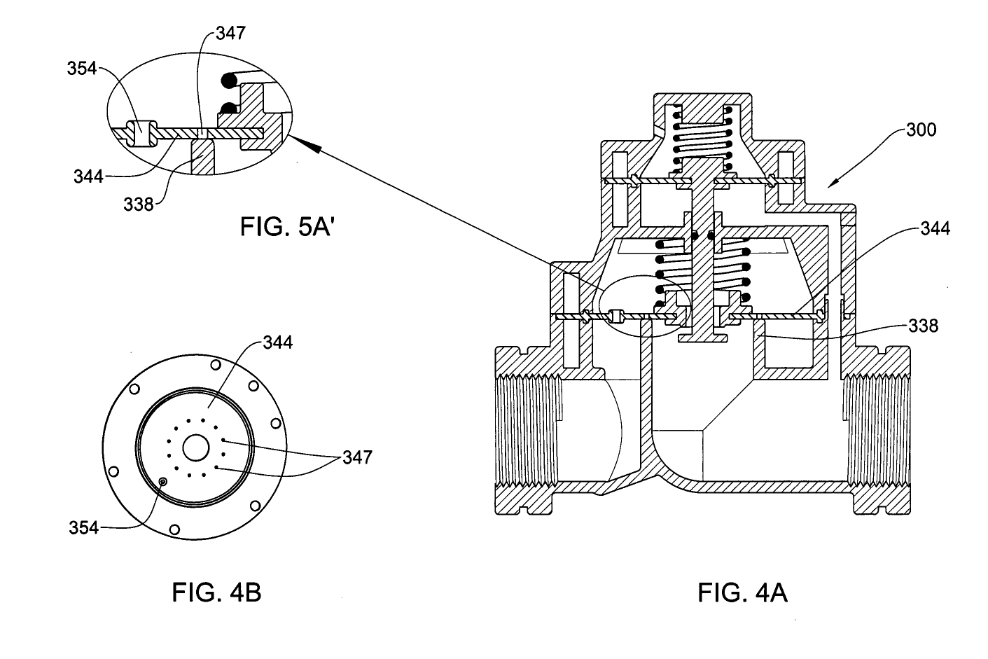

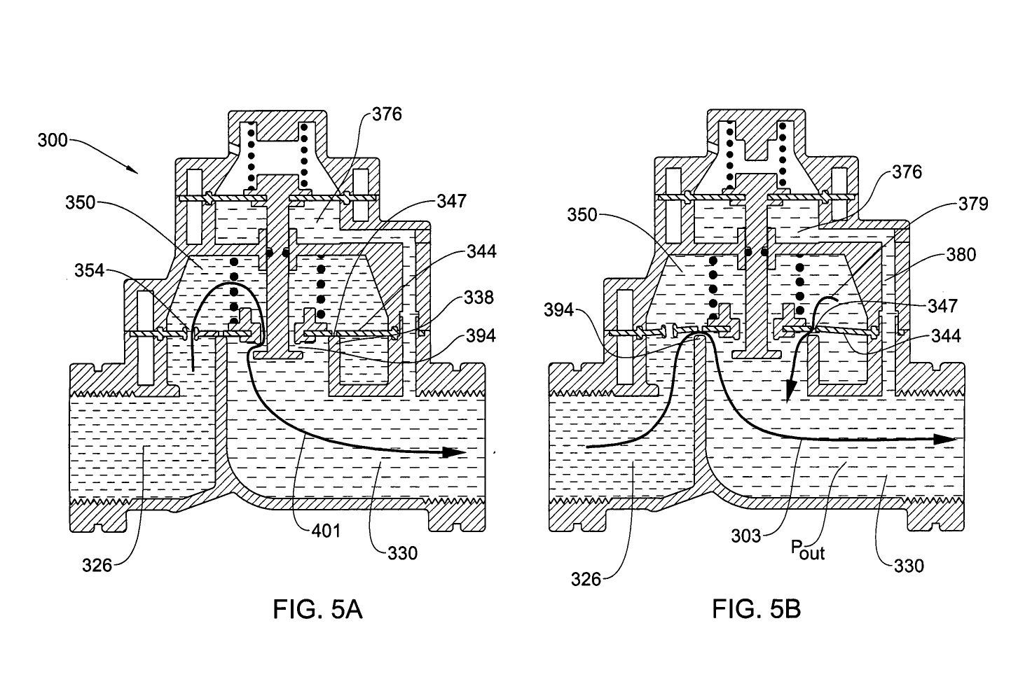

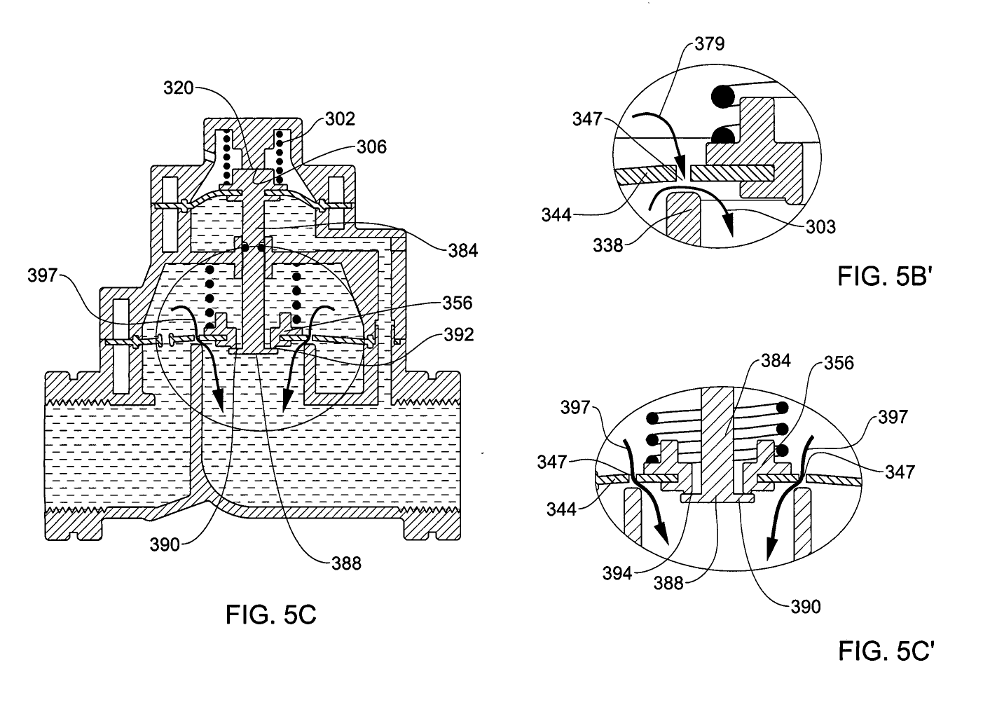

Turning now to FIGS. 4 and 5, there is illustrated a valve generally designated 300, based on the same principles as disclosed in connection with the example of FIGS. 2A-2D and wherein like elements are designated with like reference numbers, however shifted by 300.

Whilst the construction of the valve 300 follows the general construction of the valve 100 of FIGS. 1 and 2 and valve 200 of FIGS. 3, the valve 300 of FIGS. 4 and 5 differs in that the main diaphragm 344 is configured with a plurality of small apertures 347 (best seen in FIG. 4B and in FIGS. 5A′, 5B′ and 5C′), said apertures 347 being disposed about a circular path coextending with the annular sealing shoulder 338 of the hydraulic faucet.

The arrangement is such that at the closed position of the hydraulic faucet, namely when the main diaphragm 344 is at its normally closed position (FIGS. 5A and 5A′) the apertures 347 are sealingly engaged by the annular shoulder 338 prohibiting flow path therebetween.

At a leak position of the system, pressure at the outlet chamber 330 decreases along with corresponding pressure decrease at the control chamber 376, whereby downstream pressure is controlled by the pressure regulating flow path 394 facilitating fluid flow along the arrowed line 401 (at this state the pressure at the inlet chamber 326 and at the main chamber 350 is higher than the pressure at the outlet chamber 330 (Pᵢₙ=P_{mc}>Pₒᵤₜ).

Upon demand at a downstream consumer e.g. opening a tap or the like, as illustrated in FIGS. 5B and 5B′, the pressure at the outlet port 330 drops (with corresponding pressure change at the control chamber 376 via the duct 380) resulting in deformation of the main diaphragm 344 upwardly wherein at a first instance of deformation of the main diaphragm 344 low flow rate commences through the apertures 347, as indicated by arrowed line 379, accelerating pressure drop at the main chamber 350 as compared with the pressure at the inlet chamber 326, resulting in further deformation of the main diaphragm 344 to rapidly open the hydraulic faucet and facilitate high flow rate flow through the high flow rate path, as illustrated by the arrowed line 303. At this position, the inlet pressure at the inlet chamber 326 is higher than the pressure at the main chamber 350 which in turn equals the pressure at the outlet chamber 330 and at the control chamber 376 (Pᵢₙ>P_{mc}=Pₒᵤₜ).

Upon stabilization of the system (FIGS. 5C and 5C′), the control plunger 384 reaches its uppermost position wherein the top surface thereof 320 engages the restricting surface 306 of the housing, against the biasing effect of the coiled spring 302. In case that the top face 390 of the sealing head 388 of control plunger 384 sealingly engages the sealing shoulder 392 of the rigidified annular sealing member 356, thereby sealing the regulating flow path 394, the system still reaches stabilization wherein the apertures 347 still remain open to equalize pressures of main chamber and outlet chamber as illustrated by arrowed lines 397, until stabilization of the system.

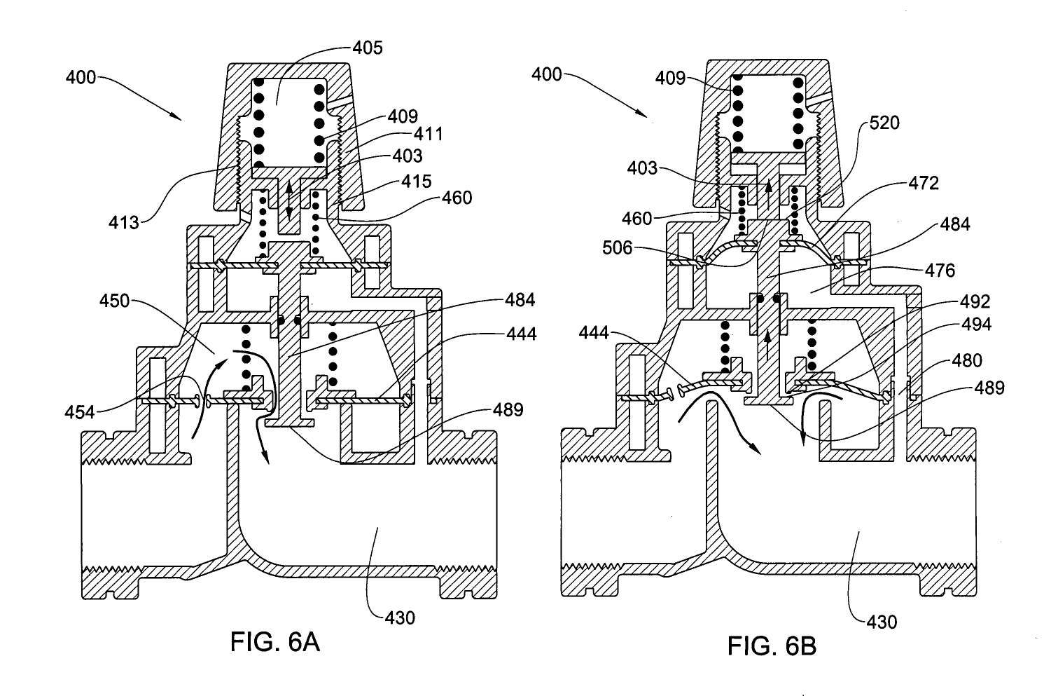

Further attention is now directed to FIGS. 6A and 6B of the drawings illustrating a two-stage flow control valve in accordance with the present disclosed subject matter, generally designated 400 and wherein elements similar to those disclosed in connection with FIGS. 4 and 5 are designated with like reference numbers, however shifted by 100.

Whilst the construction of the valve is substantially similar to that disclosed in connection with FIGS. 1 and 2, it is noted that the low flow-rate pressure regulating unit is configured with an adjustable restricting plunger 403, axially displaceable within an aired chamber 405, against a biasing spring 409, normally biasing the restricting plunger 403 downwards. According to one particular example, a housing of the valve 400 is configured with a cap 411 screw fitted at 413 to a neck portion 415 of the housing, whereby rotation of the cap 411 entails axial displacement thereof, against the coiled spring 409, thereby increasing/decreasing the force applied thereby over the restricting plunger 403. This configuration provides for a dynamic restricting member 403 providing adequate pressure control also at high flow rate upon downstream consuming.

In the position of FIG. 6A the system is illustrated at a leak position wherein the resultant pressures/forces exerted on the control plunger 484 from the outlet direction, namely those acting on the bottom surface 489 of the control plunger 484 and those acting on control diaphragm connected to the control plunger 484 are in equilibrium with those imparted by the control spring 460 and the pressure extending at the main chamber 450 and acting on the top face 490 of the control plunger 484.

In the position of FIG. 6B the system is illustrated in a demand position wherein the downstream pressure Pₒᵤₜ (at the outlet chamber 430) is regulated upon sealing of the pressure regulating flow path 494, thus preventing pressure equilibrium, wherein the pressure at the main chamber 450 increases (by fluid flow facilitated through the bleed aperture 454), as a consequence of which the main diaphragm 444 displaces back toward closed position, narrowing the high flow rate path.

When the main diaphragm 444 displaces into its open position (FIG. 6B) the pressure at the outlet chamber 430 increases corresponding entailing increase of the pressure at the control chamber 476 (owing to the open fluid flow path 480 extending therebetween) resulting in the formation of the control diaphragm 472 upwards, entailing axial displacement upwardly of the control plunger 484 such that its top surface 520 engages the bottom surface 506 of the dynamic restricting plunger 403, as a result of which the restricting plunger 403 displaces upwards against the biasing effect of the coiled spring 409.

It is thus noted that the resultant force acting on the control plunger 484 consists of the pressure applied at its bottom face 489 and by the control diaphragm acting against the combined force of the control spring 460 and the coiled spring 409 of the dynamic restricting member 403, as well as and the pressure extending at the main chamber 450 and acting on the top face 490 of the control plunger 484.

It is appreciated that other features of the valve 400 and its operation, are substantially similar to those disclosed in connection with the examples.

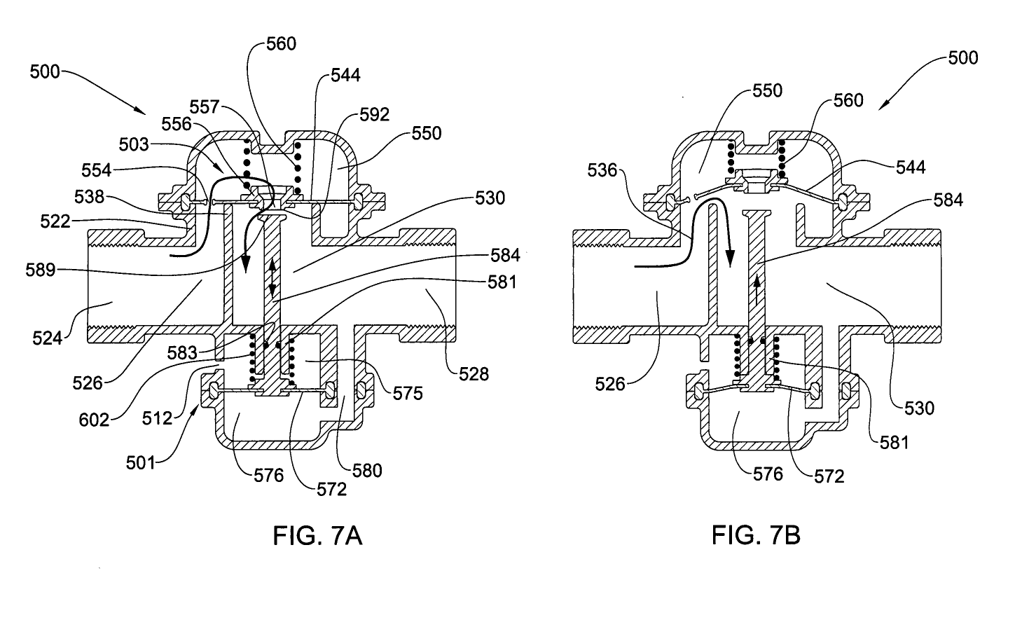

Further attention is now directed to the example illustrated in connection with FIGS. 7A and 7B illustrating a two-stage valve in accordance with a modification of the present disclosed subject matter, generally designated 500. For sake of clarification, elements which are similar by nature to those disclosed in connection with FIG. 1 are designated with like reference numbers, however shifted by 500.

In the examples illustrated hereinbefore, the low flow-rate pressure regulating unit appeared to extend coaxially above the hydraulic faucet with the control plunger extending through the main chamber and respectively through an aperture formed in the main diaphragm (wherein the control plunger was “pulled” upwards into sealing engagement with a bottom surface of the rigidified annular sealing portion). However, in the example of FIGS. 7A and 7B, the valve 500 is configured such that the low flow-rate pressure regulating unit designated 501 extends coaxially below the hydraulic faucet generally designated 503 and wherein the control plunger 585 in fact extends through the outlet chamber 530 and displaces towards engagement of the pressure regulating flow path (the rigidified annular sealing portion 592) in a direction against the biasing effect of the main diaphragm biasing spring 560 namely, the control plunger 585 is “pushed” upwards into such sealing engagement.

The construction of the valve 500 is such that the housing 522 is configured with an inlet port 524 extending to an inlet chamber 526 and further comprises an outlet port 528 extending towards the outlet chamber 530. The valve 500 is a globe-type valve wherein the high flow-rate flow path extends over an annular sealing shoulder 538 constituting a high flow-rate flow path 536 (arrowed line in FIG. 7B). The hydraulic faucet 503 comprises a main diaphragm 544 configured similarly as disclosed hereinabove for sealing engagement of the annular sealing shoulder 538 and is further configured with a bleed aperture 554, said main diaphragm further configured with a rigidified annular sealing member 556 configured in turn with a central flow path 557 and being biased downwards by means of a coiled spring 560 extending within the main chamber 550.

The low flow-rate pressure regulating unit 501 comprises a control chamber 576 being in constant open flow communication with outlet chamber 530 via a duct 580 and there is further provided a control diaphragm 572 biased away from engagement of the flow port 557 by means of a coiled control spring 602 extending within the vented chamber 575 (ventilation takes place through aperture 512), wherein the control plunger 584 is axially displaceable within a tubular support section 581 and is provided with a sealing O-ring 583, said O-ring providing adequate sealing though enabling axial displacement of the control plunger 584. The top face 589 of the control plunger 584 is configured for sealing engagement of the projecting annular shoulder 592 of the rigidified annular sealing member 556.

Operation of the valve 500 is substantially similar to that disclosed in connection with the previous embodiments wherein at a leak position (FIG. 7A) fluid flow takes places from the inlet chamber 526, through the bleed aperture 554 into the main chamber 550 and through the opening 557 towards the outlet chamber 530. As the pressure at the main chamber 550 drops with respect to the pressure at the inlet chamber 526, the main diaphragm 544 deforms upwardly against the biasing effect of the coiled spring 560 (FIG. 7B) thus giving rise to opening of the hydraulic faucet facilitating high flow-rate flow along path 536 to supply demand at the downstream consumer.

As the pressure at the control chamber 576 increases, the control diaphragm 572 deforms upwardly entailing corresponding axial displacement of the control plunger 585 until the plunger base engages a lowermost annular restricting portion of the tubular support 581, thus preventing further axial displacement of the control plunger 585, thereby preventing the system from entering the so-called unstable position (referred to hereinabove as hammering).

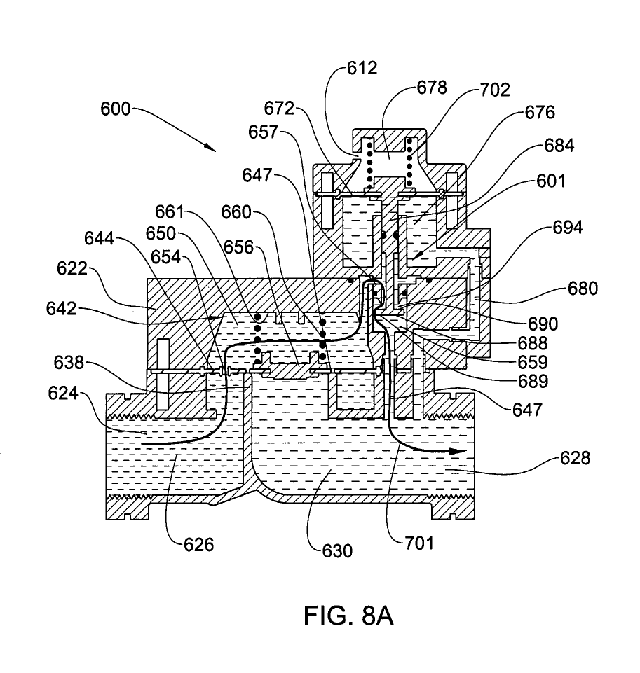

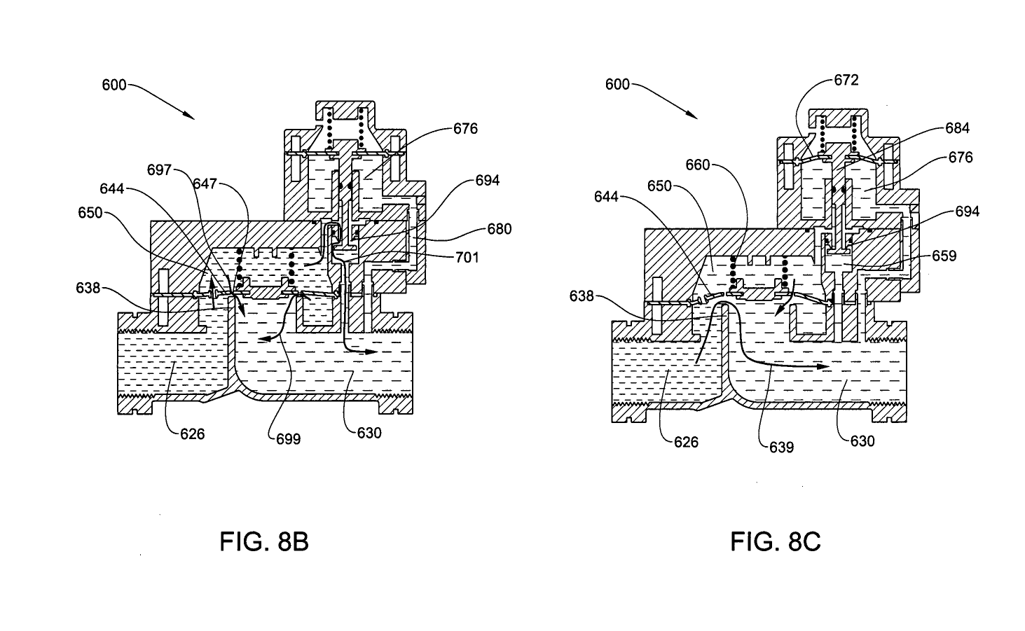

In FIGS. 8A-8C there is illustrated a two-stage valve in accordance with yet another example of the present disclosed subject matter, generally designated 600, wherein like elements are designated with like reference numbers as in FIG. 1, however shifted by 600.

The valve 600 is of a globe-type configuration, comprising an inlet port 624 extending into an inlet chamber 626, and further comprising an outlet port 628 and an outlet chamber 630. A high flow-rate hydraulic faucet is provided at 642 and comprises a main chamber 650 extending above a main diaphragm 644 configured for sealing engagement of an annular sealing shoulder 638, wherein the diaphragm 644 is configured with a bleed aperture 654 and with a rigidified annular sealing member 656 bearing a bottom end of a coiled main spring 660, in opposite end of said spring bearing against the top surface 661 of the housing 622, said coiled spring 660 biasing the main diaphragm 644 into sealing engagement of the annular sealing shoulder 638, thus sealing the high flow-rate flow path 638 (illustrated at its open position in FIG. 8C).

The diaphragm 644 is of a configuration similar to that disclosed in connection with FIGS. 4 and 5, namely is configured with a plurality of small apertures 647 disposed about a filter path coextending with the annular sealing shoulder 638 of the hydraulic faucet 642 and operating in the same fashion.

A low flow-rate pressure regulating unit 601 comprises a control chamber 676 provided with a control diaphragm 672 extending below a chamber 678 vented to the atmosphere through an aired aperture 612, said chamber 678 further accommodating a control biasing spring 702 bearing against a portion of the control plunger 684 extending through the control diaphragm 672. The control chamber 676 is in constant flow communication with the outlet chamber 630 through open duct 680.

It is thus noted that the low flow-rate pressure regulating unit 601 is disposed offset of the hydraulic faucet 642 with the regulating flow path 694 extending coaxial with the low flow-rate pressure regulating unit, and wherein a flow path 657 extends between the main chamber 650 and a top face 690 of the sealing head 688 of the control plunger 684, with its bottom face 689 being in flow communication with and exposed to the outlet chamber 630 via a duct 647.

Thus, the configuration illustrated in connection with FIGS. 8A-8C illustrates a device in which the low flow-rate pressure regulating unit 601 is separated from the high flow-rate hydraulic faucet however wherein the valve operates substantially in the same manner disclosed hereinabove. At a leak condition, represented in FIG. 8A, low flow-rate takes place at the downstream consumers (e.g. a leak at a faucet, and the like), resulting in pressure drop at the outlet chamber 630 and corresponding pressure drop at the control chamber 676 whereby the decreased pressure at the control chamber 676 resulting in control plunger 684 open position facilitating flow at a low flow rate as illustrated by arrowed line 701 (referred to as “leak-flow”). In this position the pressured inlet chamber 626 is equal to the pressure at the main chamber 650 (Pᵢₙ=P_{mc}) and likewise, the pressure at the outlet chamber 630 is equal to the pressure at the control chamber 676 and at the demi-chamber 659 below the plunger 684, however said pressure being lesser than the inlet chamber pressure. At this position, the main diaphragm 644 is disposed in its sealing position wherein the apertures 647 are sealed by the annular sealing shoulder 638.

Upon increasing flow demand (i.e. opening a faucet by one of the downstream consumers), the pressure at the outlet chamber 630 and main chamber 650 drops resulting in that the substantially higher pressure at inlet chamber 626 entails deformation of the main diaphragm 644, whereupon fluid flow commences through the apertures 647 (represented by arrowed line 697) gradually, fluid commences also above the annular sealing shoulder 638 as represented by arrowed line 699 whilst low flow-rate continues through the pressure regulating flow path 694 as represented by the arrowed line 701.

As the flow continues from the main chamber 650 into the outlet chamber 630, the pressure at the main chamber 650 drops and the pressure at inlet chamber 626 deforms the main diaphragm 644 against the biasing effect of coiled spring 660, giving rise to high flow-rate as represented by arrowed line 639 over the annular sealing shoulder 638. At this position the pressure at the main chamber 650 substantially equalizes with the pressure downstream, namely at the outlet chamber 630, control chamber 676 and at the demi-chamber 659 below the control plunger 684 whereby increase of pressure at the control chamber 676 entails deformation of the control diaphragm 672 upwardly entailing corresponding axial displacement of the control plunger 684 to thereby seal the low flow-rate flow path at 694.

Upon seize of the flow demand by the downstream consumers, the valve 600 will spontaneously shut as discussed hereinabove in connection with the previous examples.

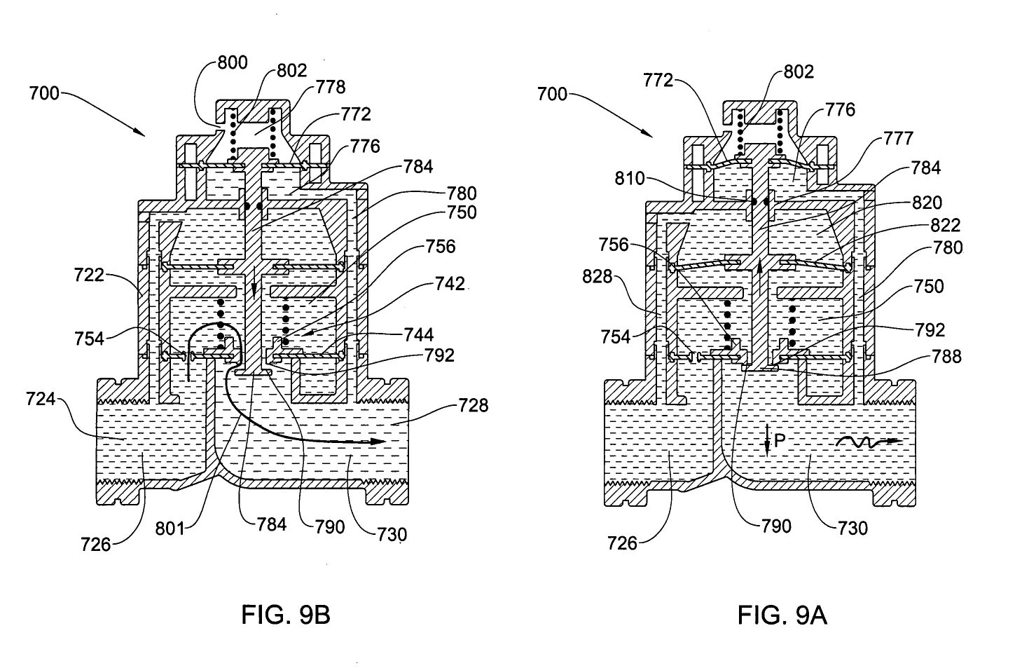

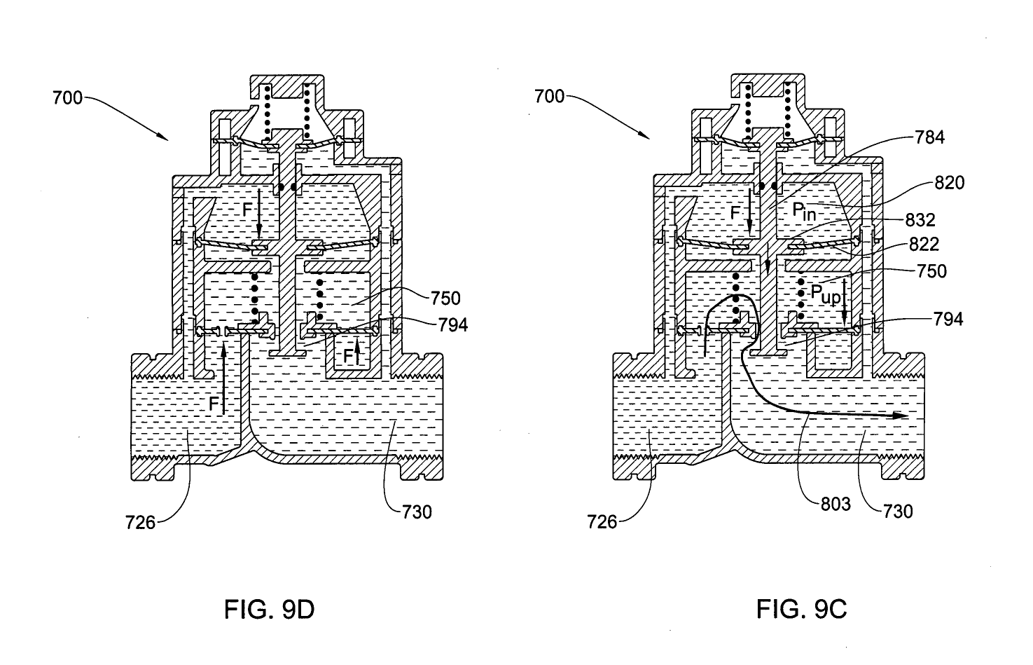

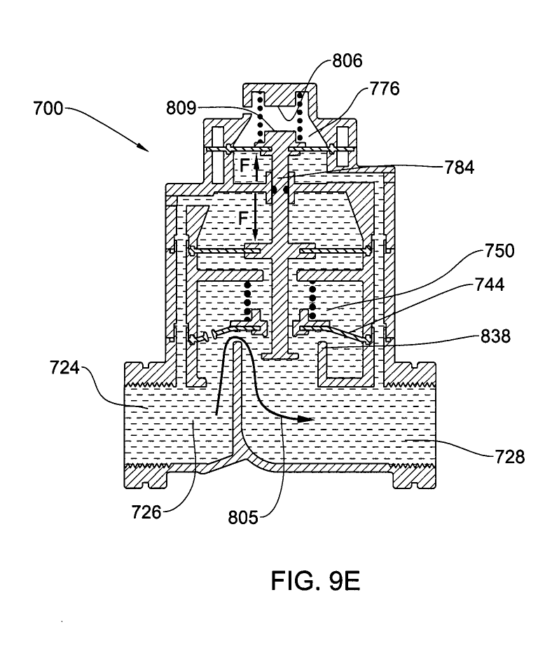

Further attention is now directed to FIGS. 9A-9E of the drawings illustrating a two-stage valve in accordance with a different example of the present disclosed subject matter.

For sake of clarification, like elements which have been disclosed in connection with the example of FIG. 1 are designated with like reference numbers, shifted by 700.

Valve 700 comprises a housing 722 configured with an inlet port 724 extending into an inlet chamber 726, and an outlet port 728 extending into an outlet chamber 730. The housing is a globe-type configuration and comprises a high flow-rate flow path configured with an hydraulic faucet 742 which is fitted with a main diaphragm 744 having a bleed aperture 754 being in flow communication with chamber 726 extending below the main diaphragm 744 and the main chamber 750 extending above the main diaphragm 744, wherein a rigidified annular sealing member 756 is fixedly configured with the main diaphragm 744 having at its bottom face a downwardly projecting sealing shoulder 792 defining a low flow-rate flow path 794 (sealed in FIG. 9A; opening FIG. 9B and represented by an arrowed line 801).

A control chamber 776 extends at a top portion of the housing 722 and is provided with a control diaphragm 772 clampingly secured to the housing and biased downwards by a coiled control spring 802 received within an aired chamber 778 vented to the atmosphere through aperture 800. Articulated to the control diaphragm 772 there is a control plunger 784 axially displaceable within the housing and secured by a tubular wall segment 777 for axial displacement therewithin, though in a sealing fashion by an O-ring 810 provided on the control plunger 784. The control chamber 776 is in flow communication with the outlet 730 via the normally constantly open flow duct 780, such that the pressure at the outlet chamber and at the control chamber is at equilibrium at all times.

Extending above the main chamber 750 there is a top chamber 820 with a release diaphragm 822 articulated to the control chamber 784 partitioning the top chamber 820 from the main chamber 750 and further wherein the top chamber 820 is at constantly open flow communication with the inlet chamber 726 via a normally, constantly open communicating duct 828 such that the pressure at the top chamber 820 is identical with that at the inlet chamber 726.

The control plunger 784 is configured at its bottom end with a plunger head 788 with a top face thereof 790 configured for sealing engagement with the annular sealing shoulder 792 of the rigidified annular sealing member 756 (as illustrated in FIG. 9A) thus closing or opening the low flow-rate flow path as will be discussed hereinafter.

At the position illustrated in FIG. 9A the valve 700 is shown upon shutting the downstream consumers, wherein the pressure when the system is temporarily at equilibrium, namely the inlet pressure at the inlet chamber 726 equals the outlet pressure at the outlet chamber 730 (Pᵢₙ=Pₒᵤₜ) and likewise, the pressure at the main chamber 750 equals the pressure at the top chamber 820 and at the control chamber 776, as illustrated at the temporary initial position of FIG. 9A.

It is noted in this position that the control diaphragm 772 is displaced upwards, against the biasing effect of the coiled spring 802 resulting in corresponding axial displacement of the control plunger 784 upwards into sealing engagement of the low flow-rate flow path, namely wherein the top face 792 sealingly engages the annular sealing shoulder 790.

As a leak takes place at any of the downstream consumers, pressure at outlet chamber 730 and consequently at the control chamber 776 decreases, resulting in displacement of the control diaphragm 772 downwards (FIG. 9B) entailing opening of the low flow-rate flow path between the annular shoulder 792 and the top face 790 of the sealing head 788 of the control plunger, facilitating low flow-rate 801 from the inlet chamber 726 through the bleed aperture 754 into the main chamber 750 and then through the low flow-rate flow path 794 out to the outlet chamber 730 and to the downstream consumers.

Upon demand at the downstream consumers, further pressure drop occurs at the outlet chamber 730 resulting in further decrease of the pressure at the main chamber 750 whilst the pressure at the inlet chamber 726 and correspondingly at the top chamber 820 remains constant, thus applying downwardly directed force on the surface 832 of the control plunger 784 and on the release diaphragm 822, resulting in further downward displacement of the control plunger 784 (FIG. 9C) thereby increasing fluid flow through the low flow-rate flow path 794 as represented by arrowed line 803, whereupon the pressure at the main chamber 750 continues to decrease into equilibrium with the pressure at outlet chamber 730 (FIG. 9D) wherein the low flow-rate flow path 794 is open to a maximum. At this stage the inlet pressure at the inlet chamber 726 overcomes the pressure at the main chamber 750, resulting in deformation of the main diaphragm 744 into its open position (FIG. 9E) facilitating fluid flow at the high flow-rate flow path represented by arrowed line 805, above the annular sealing shoulder 838 whilst this position high flow-rate flow takes place between the inlet port 724 and the outlet port 728.

It is appreciated that the valve 700 can be configured with a restricting surface 806 within the vented chamber 776 configured for restricting upward axial displacement of the control plunger 784 upon engaging with the top surface 820, 809 thereof (not shown).

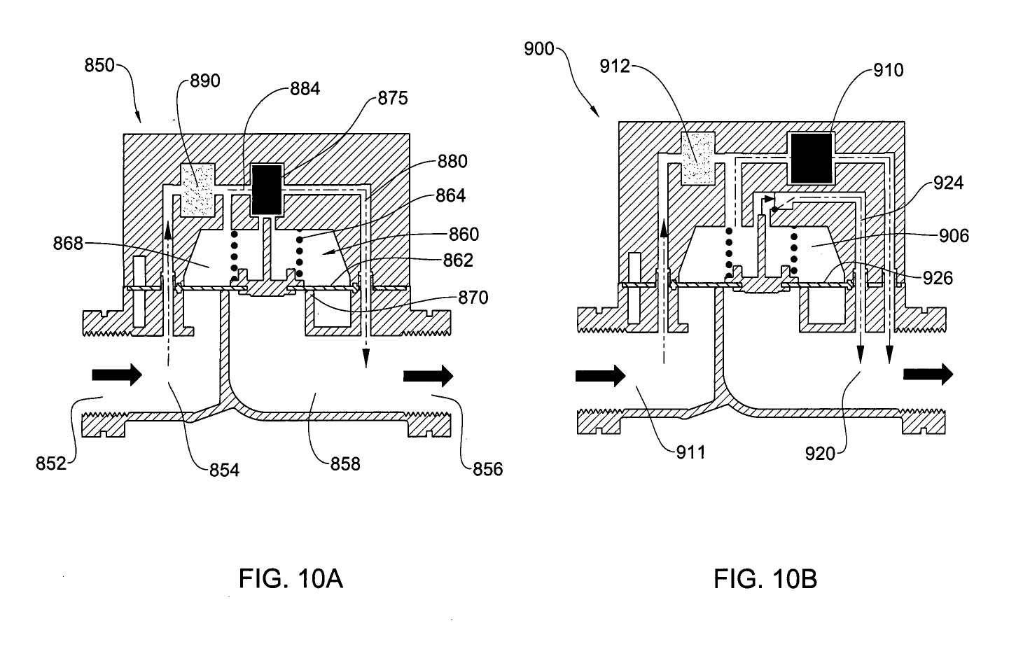

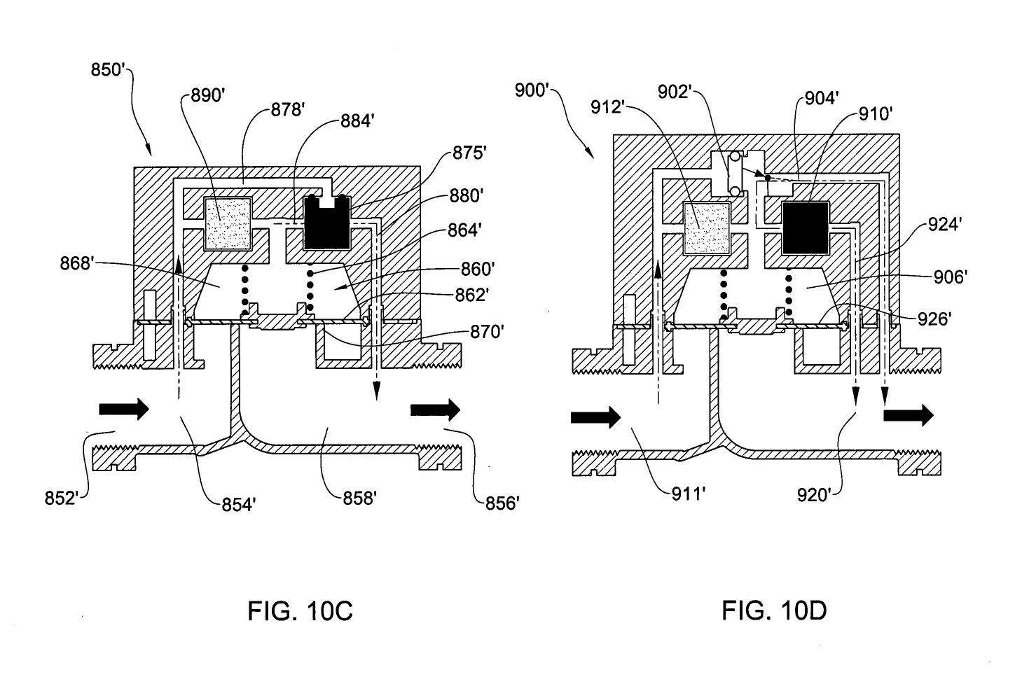

FIGS. 10A and 10B schematically summarize the concepts of the two-stage valves disclosed in the preceding figures, excluding FIG. 9. In FIG. 10A there is illustrated a valve 850 configured with an inlet port 852 extending into an inlet chamber 854 and an outlet port 856 extending from an outlet chamber 858. The valve can be, for example, a globe-type configuration and comprises a hydraulic faucet 860 configured with a main diaphragm 862 and can be, for example, spring biased by coiled spring 864 into sealing engagement of annular sealing shoulder 870 extending between the inlet chamber 854 and the outlet chamber 858 and constituting a high flow-rate flow path (sealed in FIG. 10A). A low flow-rate pressure regulating unit 875 is provided possibly within the housing of the valve and is in flow communication with the outlet chamber 858 through a duct 880. The low flow-rate pressure regulating unit 875 is also in flow communication with the main chamber 868 via a duct 884 which is further in flow communication with a flow restricting device 890 configured for generating a flow-dependent pressure drop i.e. moderately reduced pressure at low flow rates and significantly reduced pressure at high flow rates. It is however noted that apart of the fluid flow through the flow restriction device 890, there is substantially no fluid flow between the inlet chamber 854 and the main chamber 868

The configuration is such that the duct 880 facilitates for leak flow towards the outlet port 856 and further towards downstream consumers as well as for pressure release from the main chamber 868 to the outlet chamber 858, wherein pressure release is a main diaphragm's 862 displacement dependent. In this configuration the low flow-rate pressure regulating unit 875 facilitates both for fluid flow rate regulation during leak and for mechanical driven pressure regulation during demand by the downstream consumers.

Examples for valves of the above configuration, i.e. comprising a low flow-rate pressure regulating unit and having a common duct between the outlet chamber and the main chamber, for leak flow, and which is mechanically kept open during demand, for pressure equilibrium, are shown in FIGS. 1, 2, 3, 6 and 7.

FIG. 10B is principally similar to that disclosed in connection with FIG. 10A, and discloses a valve 900 further provided with a mechanically controlled, main diaphragm's 926 displacement dependent, pressure releasing unit 902 configured for opening/closing a duct 904 extending from the main chamber 906 to the outlet chamber 920. It is also comprises of the low flow-rate pressure regulating unit 910 and the flow restricting unit 912. In this configuration, duct 904 is in flow communication with the outlet chamber 920 and facilitates for obtaining pressure equilibrium during downstream demand whilst the duct 924 serves for leak flow, namely to facilitate low flow-rate into the outlet chamber 920 and down to the downstream consumers.

Examples for valves of the above configuration, where the mechanical pressure releasing unit is separate from the pressure regulating unit, and having separate ducts, one for a leak flow and the other one for pressure equilibrium between the outlet chamber and the main chamber, are shown in FIGS. 4, 5 and 8.

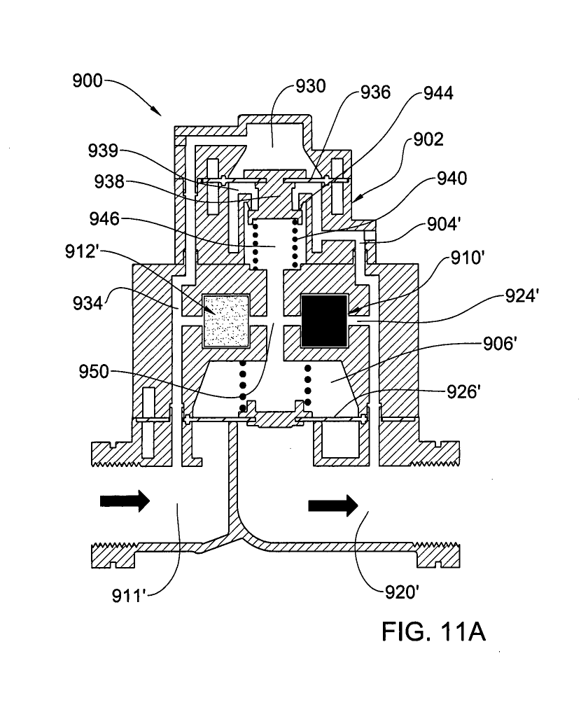

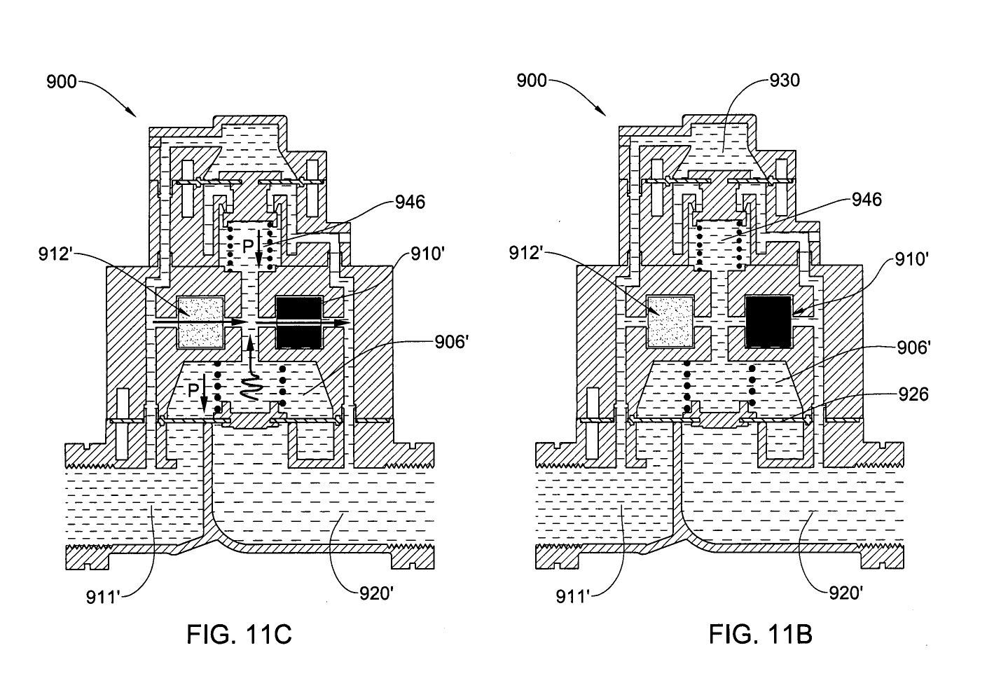

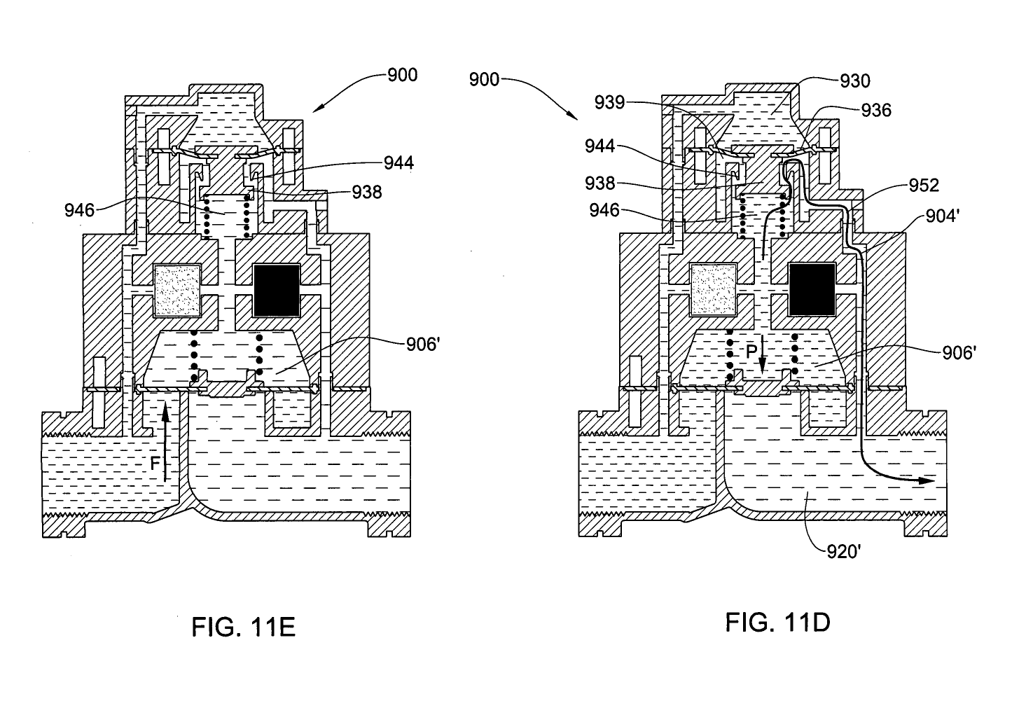

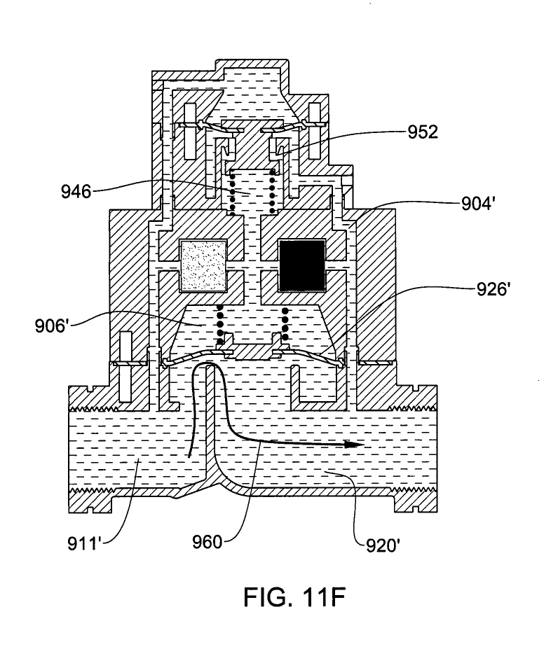

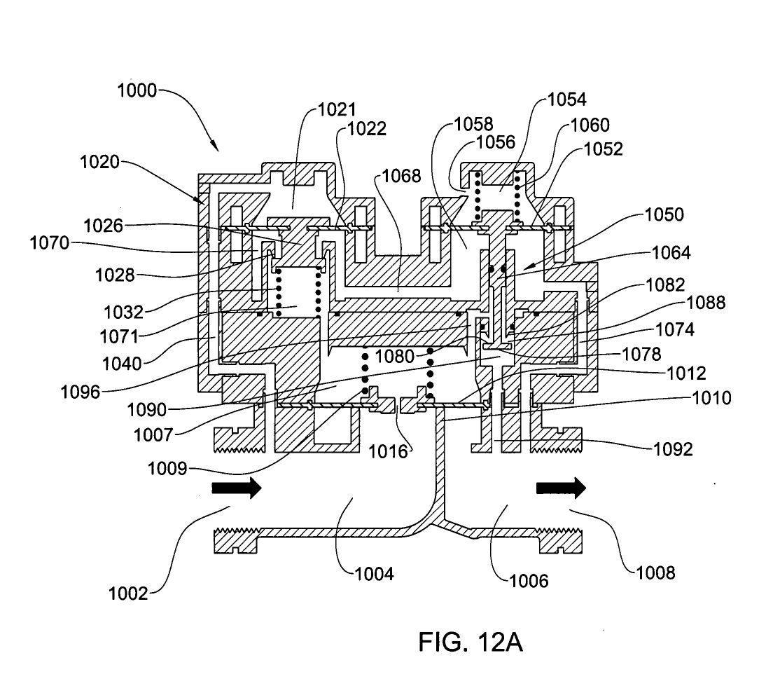

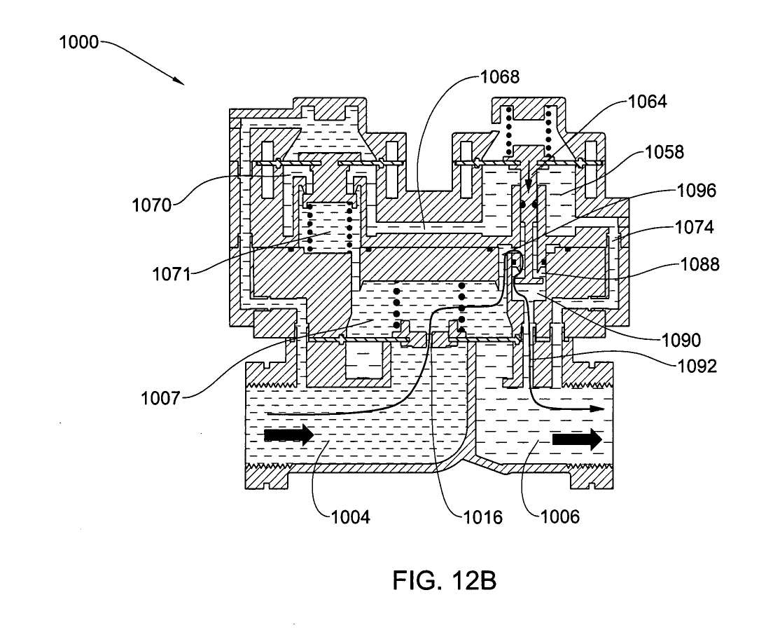

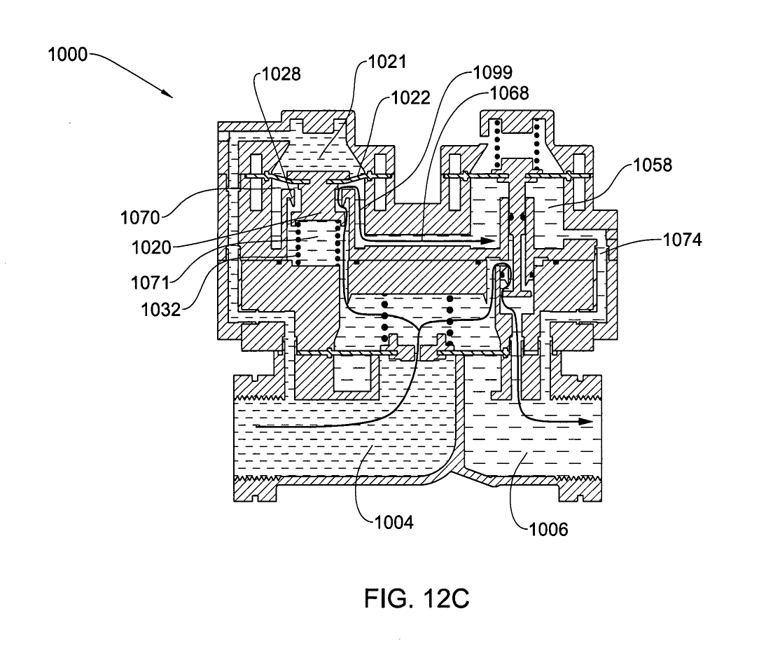

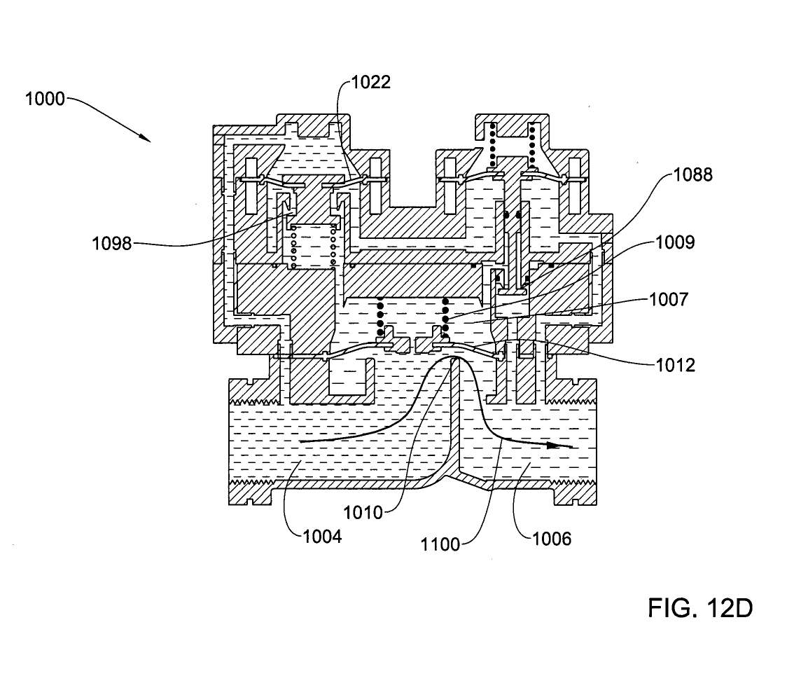

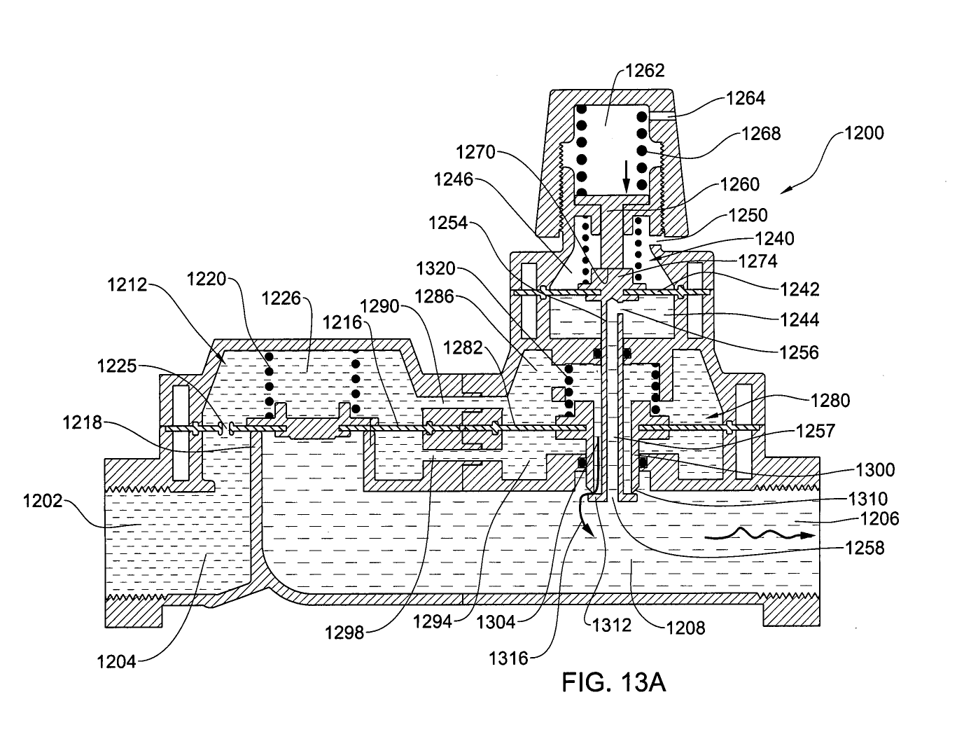

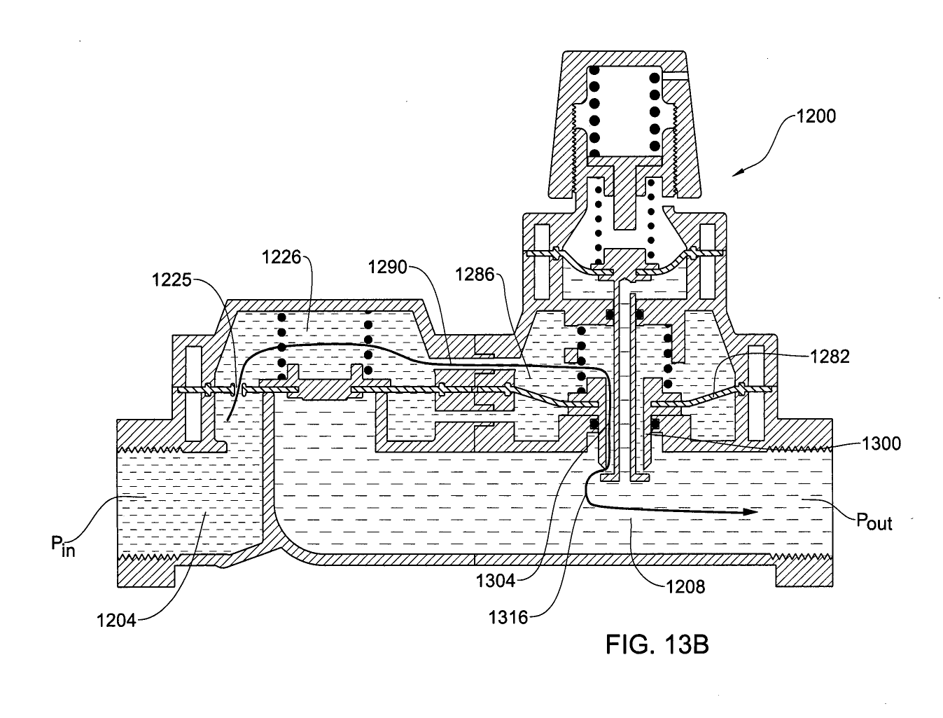

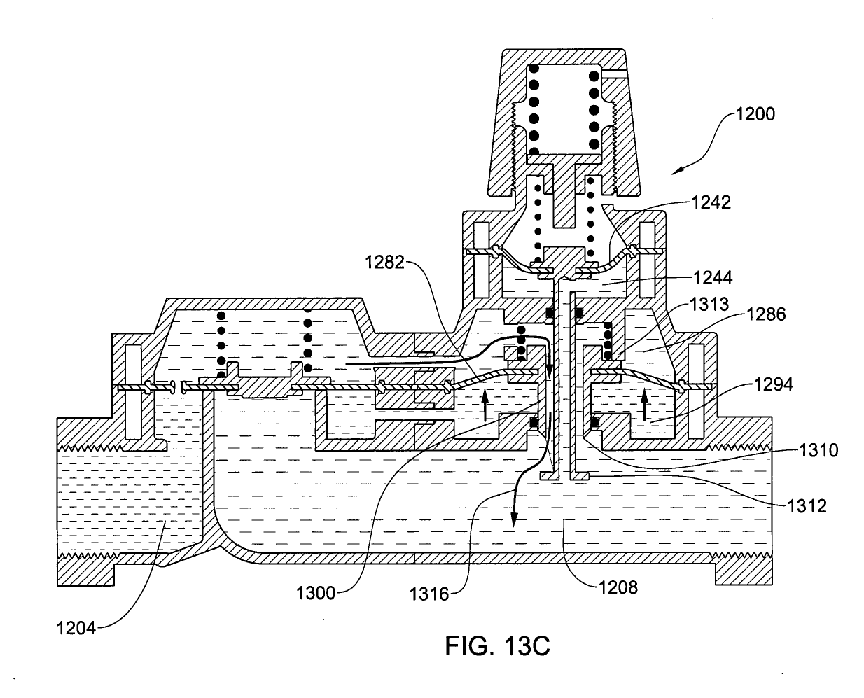

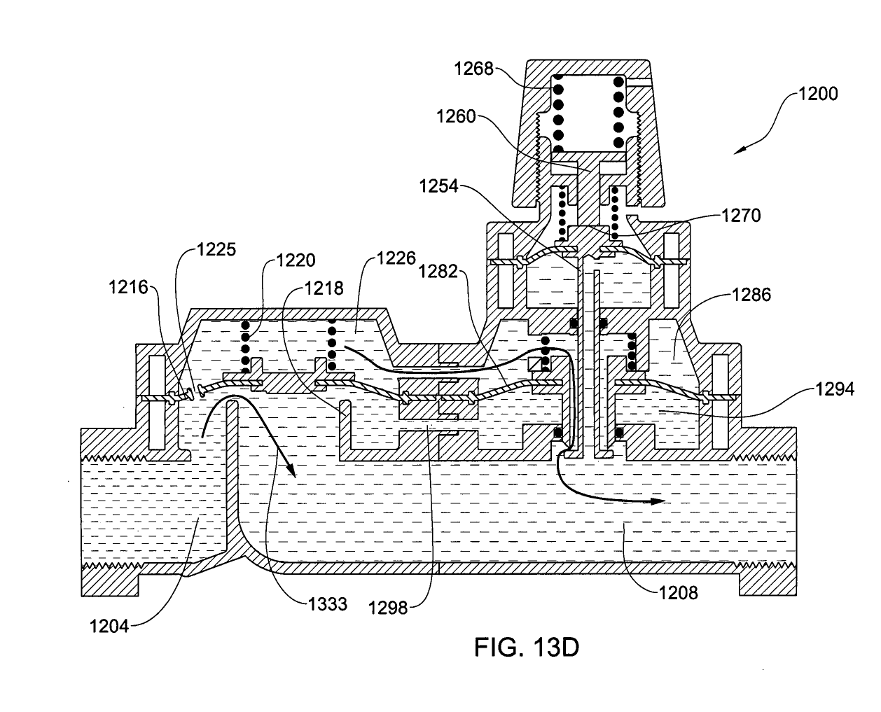

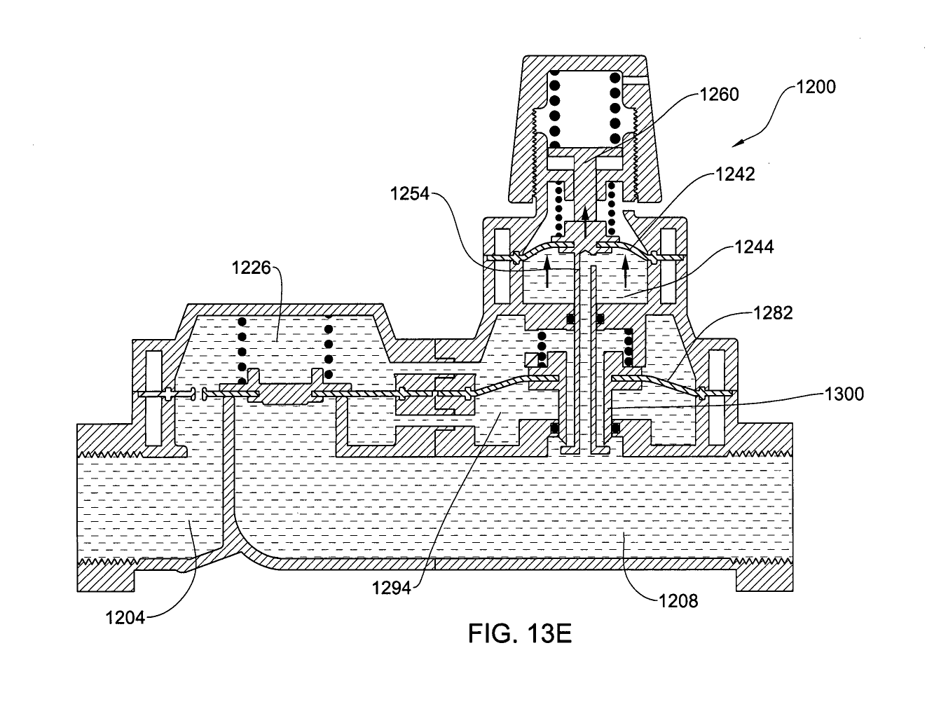

FIGS. 10C and 10D schematically illustrate further concepts of a two-stage valve in accordance with the presently disclosed subject matter. In general, the concept illustrated in FIG. 10C (described in detail with reference to FIGS. 9 and 13) is similar to the concept of FIG. 10A, the only difference being in that the pressure releasing function of the pressure regulating unit is preformed hydraulicaly and not mechanically. The concept illustrated in FIG. 10D (described in detail with reference to FIGS. 11 and 12) is similar to the concept of FIG. 10B, the only difference being in that the releasing unit is hydraulic and not mechanically linked to main diaphragm.

In FIG. 10C there is illustrated a valve 850′ configured with an inlet port 852′ extending into an inlet chamber 854′ and an outlet port 856′ extending from an outlet chamber 858′. The valve can be, for example, globe-type configuration and comprises a hydraulic faucet 860′ configured with a main diaphragm 862′ and can be, for example, spring biased by coiled spring 864′ into sealing engagement of annular sealing shoulder 870′ extending between the inlet chamber 854′ and the outlet chamber 858′ and constituting a high flow-rate flow path (sealed in FIG. 10C). A low flow-rate pressure regulating unit 875′ is provided, possibly within the housing of the valve and is in flow communication with the inlet chamber 854′ through a duct 878′ and in flow communication with the outlet chamber 858′ through a duct 880′. The low flow-rate pressure regulating unit 875′ is also in flow communication with the main chamber 868′ via a duct 884′ which is further in flow communication with a flow restricting device 890′ configured for generating a flow-dependent pressure drop i.e. moderately reduced pressure at low flow rates and significantly reduced pressure at high flow rates. The pressure regulating unit 875′ is in flow communication with the duct 878′. It is however noted that apart of the fluid flow through the flow restriction device 890′, there is substantially no fluid flow between the inlet chamber 854′ and the main chamber 868′.

The configuration is such that the duct 880′ facilitates for leak flow towards the outlet port 856′ and further towards downstream consumers as well as for pressure equilibrium between the main chamber 868′ and the outlet chamber 858′ at demand position. In this configuration the low flow-rate pressure regulating unit 875′ facilitates both for fluid flow rate regulation during leak and for pressure regulation during demand by the downstream consumers.

FIG. 10D is principally similar to that disclosed in connection with FIG. 10C, and discloses a valve 900′ further provided with a hydraulic control unit 902′ configured for opening/closing a duct 904′ extending from the main chamber 906′ to the outlet chamber 920′ (pressure release path). It is also comprises of the low flow-rate pressure regulating unit 910′ and the flow restricting unit 912′. In this configuration, duct 904′ is in flow communication with the outlet chamber 920′ and facilitates for obtaining pressure equilibrium during downstream demand whilst the duct 924′ serves for leak flow, namely to facilitate low flow-rate into the outlet chamber 920′ and down to the downstream consumers.

The hydraulic unit 902′ operates responsive to pressure differential between the inlet chamber 911′ and the main chamber 906′ above the main diaphragm 926′. Hydraulic unit 902′ makes use of the fact that upon pressure decrease within the main chamber 906′ there is a need for opening of the main flow path, namely high flow-rate path to provide demand flow for downstream consumers. Thus, upon sensing of a pressure differential, the hydraulic unit 902′ opens a flow passage between the main chamber 906′ and the duct 904′, facilitating pressure equilibrium. It is however noted that apart for fluid flow through the flow restriction device 912′, there is substantially no fluid flow between the inlet chamber 911′ and the main chamber 906′.

The arrangement disclosed in this example enhances pressure release from the main chamber 906′, at constant pressure differential, regardless of the inlet pressure and regardless of initial displacement of the main diaphragm 926′ into its open position.

A practical application of the hydraulic unit example illustrated in FIG. 10D is disclosed hereinafter with reference to FIGS. 11A-11F, using the same reference numbers as referred to in FIG. 10D.

In this example, the hydraulic unit 902′ comprises a release chamber 930 being in constant flow communication with the inlet chamber 911′ via normally open duct 934, said chamber 930 extending above a release diaphragm 936 supporting a sealing member 938 which is spring biased by means of a coiled spring 940 upwardly, into sealing engagement with an annular sealing shoulder 944 of an intermediate chamber 946 which is in normal flow communication with the main chamber 906′ via a duct 950.

The arrangement is such that the force that may reside as a result of downstream pressure at the outlet chamber 920′ is significantly low. When the pressure at the upstream (namely at inlet chamber 911′) and the pressure within the intermediate chamber 946 (similar to that as in the main chamber 906′) are substantially equal, the hydraulic unit 902′ is sealed whilst upon pressure differential, even significantly lower, the flow path between the intermediate chamber 946 and the duct 904′ opens, namely upon disengagement of the sealing member 938 from the annular sealing shoulder 944 as illustrated hereinafter (FIG. 11D). This arrangement is thus sensitive to pressure differential between the inlet chamber 911′ and the main chamber pressure at 906′, and on the other hand is indifferent or less sensitive to pressure changes at the outlet chamber 920′ and absolute inlet pressure. This is obtained by the ratio of cross sectional areas over the release diaphragm 936, having top face thereof exposed to the inlet pressure and a bottom face thereof exposed to the outlet pressure.

At a leak flow, as illustrated in FIG. 11B, where one of the downstream consumers leaks (substantially low flow rate) flow is facilitated from the inlet chamber 911′, through the flow restricting device 912′, and then out through the low flow-rate pressure regulating unit 910′ from where it flows through duct 924′ to the outlet chamber 920′ and then to the downstream consumers. It is noted that the main diaphragm 926′ remains sealed at this position and further it is seen that the pressure at the inlet chamber 911′ extends to the release chamber 930, said pressure at the main chamber 906′ and at the intermediate chamber 946 (pressure regulated through the flow restricting device 912′).

Upon demand, when a downstream consumer is opened to high flow rate (FIG. 11C) flow through the flow restricting device 912′ increases as well as flow through the low flow-rate pressure regulating unit 910′ resulting in pressure drop at the main chamber 906′ and at the intermediate chamber 946 whereupon the pressure release system comes into action owing to pressure drop at the intermediate chamber 946. In this state (FIG. 11D) pressure at the release chamber 930 overrides the coiled spring 940, the pressure at the intermediate chamber 946 and the pressure at a bottom chamber 939 exposed to the outlet chamber resulting in downward displacement of the release diaphragm 936 such that the sealing member 938 now disengages from the annular sealing member 944 opening the pressure release path as indicated by arrowed line 952 extending between the main chamber 906′, the intermediate chamber 946 and out through the duct 904′ to the outlet chamber 920′. This causes pressure drop at the main chamber 906′ and at the intermediate chamber 946, resulting in maximal opening of the pressure release path between the annular sealing member 944 and the sealing member 938, resulting in further decrease of pressure at the main chamber 906′ (FIG. 11E) which in turn results in deformation of the main diaphragm 926′ (FIG. 11F) into its open position, facilitating high flow-rate between the inlet chamber 911′ and outlet chamber 920′ as illustrated by arrowed line 960.

At this position, the open pressure release path at 952 facilitates pressure equilibrium between the main chamber 906′ and the communicating intermediate chamber 946 and the outlet chamber 920′, in virtue of the open duct 904′ and while flow-rate pressure regulating unit 910′ is sealed.

FIGS. 12A-12D illustrate a specific, detailed example of a valve in accordance with the principles disclosed in connection with FIGS. 10D and 11. The valve, generally designated 1000 comprises an inlet port 1002 extending into an inlet chamber 1004 and further comprises an outlet chamber 1006 extending to an outlet port 1008. The valve is a globe-type valve comprising a hydraulic faucet configured of an annular sealing member 1010 sealingly engageable by a central diaphragm 1012 configured with a central bleed-opening 1016. Integrated with the housing of the valve there is a pressure release unit generally designated 1020 comprising a release chamber 1021 extending above a release diaphragm 1022 articulated with a rigid sealing member 1026 and configured for sealing engagement with an annular sealing shoulder 1028 integrated with the housing. The sealing member 1026 is spring biased by coiled spring 1032 into sealing engagement with the annular sealing shoulder 1028.

The release chamber 1021 is in constant open flow communication with the inlet chamber 1004 via duct 1040.

A low flow-rate pressure regulating unit generally designated 1050 comprises a control diaphragm 1052 extending between a vented chamber 1054 vented to the atmosphere through an aperture 1056 and extending above a control chamber 1058, said diaphragm being spring biased downwardly by a coiled spring 1060 extending within the vented chamber 1054 and supporting against the control plunger 1064. The control chamber 1058 is in flow communication through duct 1068 with the bottom chamber 1070 extending below the release diaphragm 1022 and said control chamber 1058 is further in flow communication with outlet chamber 1006 via a constantly open duct 1074.

The control plunger 1064 is configured with a sealing head 1078, a top face thereof 1080 configured for sealing engagement with a downwardly projecting annular sealing shoulder 1082 of a housing, giving rise to a low flow-rate flow path 1088 extending into an intermediate chamber 1090 which in turn is in flow communication with outlet chamber 1006 via a duct 1092, wherein the low flow-rate flow path 1088 is in flow communication with the main chamber 1007 via a duct 1096.

FIG. 12B illustrates the valve 1000 at a leak flow state, namely wherein a downstream consumer leaks, resulting in pressure drop at the outlet chamber 1006. It is now appreciated that the pressure at the outlet chamber 1006 is substantially equal to the pressure at the control chamber 1058 and at the bottom chamber 1070 through ducts 1074 and 1068, respectively. The pressure drop at the outlet chamber 1006 and correspondingly at the control chamber 1058 entails downward displacement of the control plunger 1064 into opening of the low flow path 1088, thereby facilitating low flow-rate flow from the inlet chamber 1004 via the flow restricting aperture 1016, into the main chamber 1007, through duct 1096, into the intermediate chamber 1090 and through duct 1092 out to the outlet chamber 1006 and out to the downstream consumers (not shown).

Demand at the downstream consumers results in pressure decrease at the outlet chamber 1006 increases and in pressure decrease at the main chamber 1007. Pressure at the release chamber 1021 which is at pressure corresponding with the pressure at the inlet chamber 1004 exceeds the pressure at the intermediate chamber 1071, resulting in deformation of the release diaphragm 1022 downwards, against the biasing effect of coiled spring 1032, giving rise to opening the flow passage between the sealing member 1026 and the annular sealing shoulder 1028, such that the fluid flow extends along arrowed line 1099 and through duct 1068 into the control chamber 1058 and out through duct 1074 to the outlet chamber 1006 and out to any downstream consumers, as illustrated in FIG. 12C.

At demand position, the release diaphragm 1022 remains fully opened (FIG. 12D), facilitating fluid flow through the release passage 1098 whereupon pressure at the main chamber 1007 decreases to a level wherein the pressure at the inlet chamber 1004 is sufficient to deform the main diaphragm 1012 into its open position, against the biasing effect of the coiled spring 1009, giving rise to high flow-rate between the inlet chamber 1004 and the outlet chamber 1006, over the annular sealing shoulder 1010, as represented by arrowed line 1100, however wherein the low flow-rate flow path at 1088 now displaced into its closed position.

Turning now to FIGS. 13A-13E there is illustrated yet another example of a two-stage valve generally designated 1200, in accordance with the disclosed subject matter.

The valve 1200 is configured with an inlet port 1202 extending into an inlet chamber 1204 and further configured with an outlet port 1206 extending from an outlet chamber 1208, in a globe-type configuration.

A hydraulic faucet 1212 constitutes a high flow-rate flow path between the inlet chamber 1204 and the outlet chamber 1208 and is configured with a main diaphragm 1216 configured for sealing engagement of an annular sealing projection 1218 extending between the inlet chamber 1204 and outlet chamber 1208, said main diaphragm 1216 being normally urged into sealing engagement with the annular sealing projection 1218 by a coiled compression spring 1220.

The main diaphragm 1216 is further provided with a bleed aperture 1225 facilitating fluid flow between the inlet chamber 1204 and the main chamber 1226 extending above the main diaphragm 1216.

A low flow-rate pressure regulating unit 1240 comprises a control diaphragm 1242 extending above a control chamber 1244, said control diaphragm 1242 extending below a chamber 1246 vented to the atmosphere through an aperture 1250. The control diaphragm 1242 is articulated with a control plunger 1254 which is in the form of a hollow tubular member configured at its top end with an opening 1256 being in flow communication with the control chamber 1244 and having an open bottom end at 1258 opening into the outlet chamber 1208. Extending above the top end of the control plunger 1254 there is a regulatable restricting member 1260 which is axially displaceable within a chamber 1262 opened to the atmospheric pressure through an aperture 1264, said restricting plunger 1260 being urged downwards by means of a biasing spring 1268, its bottom face 1270 configured for engagement with a top head face 1274 of the control plunger 1254 as will be discussed hereinafter.

A pressure release unit generally designated 1280 comprises a release diaphragm 1282 extending between a top chamber 1286 which is in flow communication with the main chamber 1226 via duct 1290, and a bottom chamber 1294 extending below the release diaphragm 1282, said bottom chamber 1294 being in flow communication with inlet chamber 1204 via duct 1298.

The release diaphragm 1282 is articulated to an axially displaceable sleeve 1300 coaxially mounted over the control plunger 1254 and facilitating fluid flow at an annular interstice 1304 extending therebetween and facilitating a low flow-rate flow path between a lowermost annular sealing shoulder 1310 of the sleeve 1300 and a laterally projecting bottom head portion 1312 of the control plunger 1254, said low flow-rate path illustrated by arrowed line 1316. As can further be seen, the sleeve 1300 is biased downwards by means of a coiled spring 1320.

In FIG. 13A the system is illustrated at a closed position. As leak commences (FIG. 13B), pressure at the outlet chamber 1208 drops wherein leak flow takes place from the inlet chamber 1204, through bleed aperture 1225, into the main chamber 1226, through duct 1290 into the top chamber 1286, and then, through the interstice 1304, along a low-flow rate passage 1316 out towards the downstream consumers.

It is seen that in this condition the release diaphragm 1282 deforms downwards, entailing corresponding downward displacement of the sleeve 1300, though not sealing the low flow-rate passage flow.

As a downstream consumer, e.g. a tap is opened (FIG. 13C) pressure at the outlet chamber 1208 drops, entailing corresponding pressure change at the control chamber 1244 resulting in the formation of the control diaphragm 1242 downwards, resulting in increase of the flow passage extending annular sealing shoulder 1310 and annular projecting sealing head 1312 and further whereby, the pressure at the upper chamber decreases as opposed to the pressure at the lower chamber (which actually remains constant), resulting in the formation of the release diaphragm 1282 upwards, entailing corresponding axle displacement of the sleeve 1300, thereby increasing flow passage at 1316.

It is noted the sleeve 1300 displaces actually upwards until it reaches a restricting stopper 1313 preventing its further axle displacement.

The pressure differential over the main diaphragm 1216 entails its deformation, against the biasing spring 1220 (FIG. 13D) resulting in opening of the high flow-rate path over the annular filling shoulder 1218, as represented by the arrowed line 1333, whereupon pressure at the outlet chamber increases, entailing upwardly directed displacement of the control plunger 1254 until it engages the bottom face 1270 of the restricting plunger 1260, displacing together against the biasing effect of spring 1268, wherein the downstream pressure Pₒᵤₜ (at the outlet chamber 1208) is regulated upon sealing of the pressure regulating flow path 1316 wherein the pressure at the main chamber 1226 increases (by fluid flow facilitated through the bleed aperture 1225) as a consequence of which the main diaphragm 1216 displaces back into closing the high flow rate path.

Upon the closing on the demand flow at the downstream consumers (FIG. 13E) pressure throughout the system momentarily increases wherein, the pressure at the inlet camber 1204 substantially equals to the pressure at the outlet chamber 1208 and the respective main chamber 1226, control chamber 1244 and lower chamber 1294.

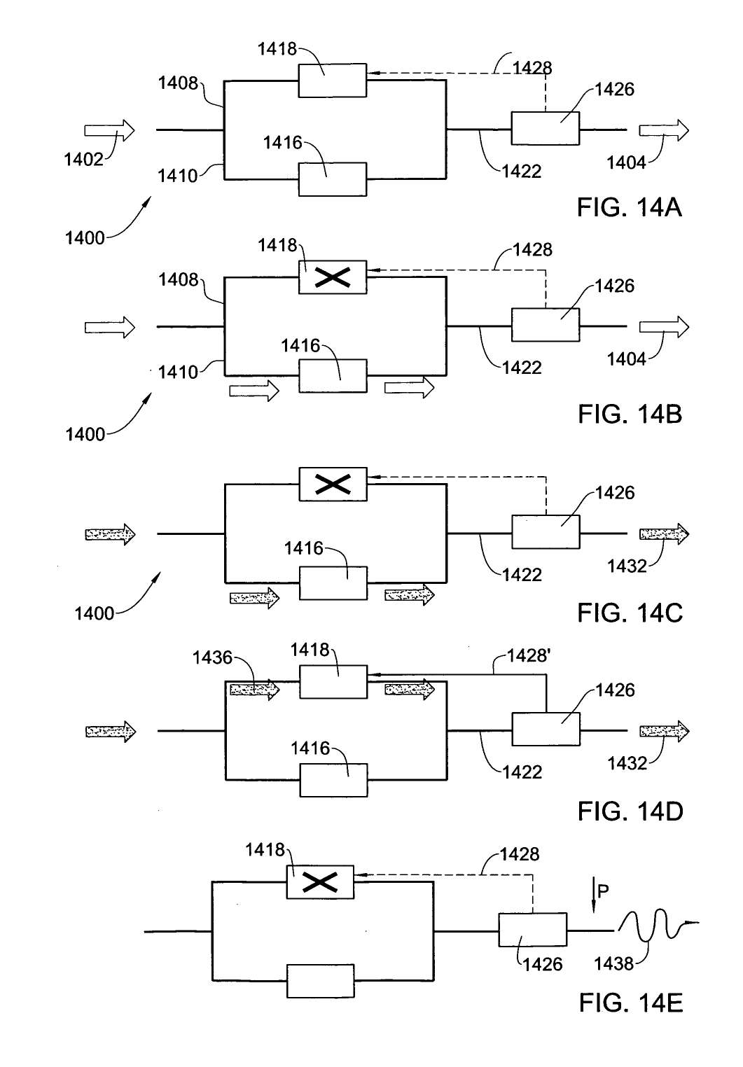

Turning now to the example illustrated in the block diagram of FIGS. 14A-14D there is illustrated a valve control system generally designated 1400 comprising an inlet port 1402 and an outlet port 1404 wherein the inlet port 1402 splits into two parallel extending flow lines 1408 and 1410, wherein the line 1410 is configured with a low-pressure regulating valve 1416 and the line 1408 is configured with an electric operated faucet 1418. The two lines 1408 and 1410 join together after the respective device is fitted thereon into an outlet line 1422 fitted with a flow detector 1426 configured for generating a control signal 1428 and transmitting said signal to the electric faucet 1418.

At a leak state of the system (FIG. 14B) the flow detector 1426 does not generate an electric signal to the electric faucet 1418 whereby the electric faucet remains closed such that there is no flow through the line segment 1408, whereby fluid flow takes place only through the line section 1410 and through the respective low-pressure regulating valve 1416 and then out through the outlet line 1422 towards the outlet port 1404.

FIGS. 4C and 4D illustrate the position upon demand at a downstream consumer, i.e. opening of a tap and the like. As the high flow rate commences, represented by arrow 1432 the flow rate through the low-pressure regulating valve 1416 rises to whereupon the flow sensor 1426 senses the high flow-rate and generates a control signal 1428′ (FIG. 14D) to the electric faucet 1418, whereupon the faucet opens and thus commences high flow-rate therethrough, represented by thickened arrows 1436.

Upon seizing the demand at the downstream consumer (FIG. 14E) the flow sensor 1426 senses the change of flow-rate and stops the signal at 1428 to the electric faucet 1418 wherein at a first stage the system reaches pressure equilibrium and shortly thereafter the leak flow regime takes place (represented by leak 1438) whereby the system moves into the leak-flow condition as in FIG. 14B.

Whilst there have been shown some examples of the disclosed subject matter, it is to be understood that many changes may be made therein without departing from the spirit of the invention, mutatis mutandis.

1.-31. (canceled)

32. A two-stage valve, comprising:
a housing fitted with an inlet port extending to an inlet chamber and configured for coupling to an upstream liquid supply line, and an outlet port extending from an outlet chamber and configured for coupling to a downstream supply line;
a high flow-rate path extending between the inlet chamber and the outlet chamber fitted with a hydraulic element configured for selectively admitting liquid flow therebetween at a demand position defined by substantially high flow; and
a pressure regulating unit configured for controlling a pressure regulating flow path providing direct or indirect flow communication between the inlet chamber and the outlet chamber for allowing liquid flow therebetween at a leak position defined by substantially low flow rates.

33. The two-stage valve according to claim 32, further comprising a mechanism for opening said high flow-rate path upon a demand for liquid downstream.

34. The two-stage valve according claim 32, wherein the high flow-rate path fitted with a hydraulic faucet comprising a main diaphragm extending between the inlet chamber and the outlet chamber configured for selectively admitting said liquid flow therebetween at substantially high flow rates.

35. The two-stage valve according to claim 34, further comprising a main chamber extending at one face of the main diaphragm and configured with a restricted flow path extending between an inlet chamber and the main chamber.

36. The two-stage valve according to claim 32, wherein said pressure regulating unit is configured with a control chamber fitted with a control diaphragm having one face in normally open flow communication with the outlet chamber and at an opposite face thereof is vented to the atmosphere.

37. The two-stage valve according to claim 36, wherein said pressure regulating unit is configured with a control plunger, wherein said control diaphragm and control plunger are configured for controlling a pressure regulating flow path, and extends in flow communication between the main chamber and the outlet chamber.

38. The two-stage valve according to claim 34, wherein the hydraulic faucet and the low flow-rate pressure regulating unit are integrated in a uniform housing, said hydraulic faucet and low flow-rate pressure regulating unit extending coaxially on top or below one another, at one side of the housing or at two sides thereof, or at a side-by-side configuration.

39. The two-stage valve according to claim 38, wherein the pressure regulating flow path is configured with an annular sealing portion fitted at the main diaphragm and a control plunger comprising a flow control end with a respective sealing head for sealing engagement of the annular sealing portion.

40. The two-stage valve according to claim 39, wherein the low flow-rate pressure regulating unit extends coaxially to hydraulic faucet, wherein a control plunger of the pressure regulating unit extends through the outlet chamber and displaces towards sealing of the pressure regulating flow path in direction against the sealing direction of the main diaphragm.

41. The two-stage valve according to claim 39, wherein the low flow-rate pressure regulating unit extends coaxially to hydraulic faucet, wherein a control plunger of the pressure regulating unit extends through the main chamber and further through said annular sealing portion fitted at the main diaphragm, and displaces towards sealing of the pressure regulating flow path in direction against the sealing direction of the main diaphragm.

42. The two-stage valve according to claim 37, wherein the main diaphragm is spring biased into sealing engagement of the high flow rate path and the control plunger being spring biased in direction to allow flow through the pressure regulating flow path.

43. The two-stage valve according claim 34, wherein the main diaphragm is configured with an annular sealing portion, wherein the annular sealing portion is configured for press sealing against an annular sealing shoulder defining the high flow-rate flow path.

44. The two-stage valve according to claim 37, wherein the pressure release is performed by restricting member configured to restrict axial displacement of a control plunger of the pressure regulating unit, at an open state of the high flow-rate path.

45. The two-stage valve according to claim 37, wherein the hydraulic pressure release is performed by an intermediate chamber with an intermediary diaphragm having one side in flow communication with the inlet chamber and another side in flow communication with the main chamber; and wherein said intermediary diaphragm is articulated with the control plunger of the pressure regulating unit such that pressure differential over the intermediary diaphragm entails corresponding displacement of the control plunger.

46. The two-stage valve according to claim 40, wherein a hydraulic pressure release unit is provided between the main chamber and the outlet chamber, for selectively equalizing pressure between the main chamber and the outlet chamber.

47. The two-stage valve according to claim 33, wherein a low-pressure regulating valve and an electric faucet extending in parallel flow relation to one another, each having an inlet in flow communication with the inlet port and outlet in flow communication with the outlet port; and a flow sensor extending upstream of said outlet port or else extending downstream of said inlet port and configured for generating a flow control signal responsive to fluid flow and transmitting said signal to said electric faucet.

48. The two stage flow control valve according to claim 47, wherein the high flow rate through the flow sensor results in generating a control signal to open the electric faucet and low flow rate through flow sensor entails shutting said electric faucet and resulting in directing low flow through the low-pressure regulating valve.

49. A two-stage valve, comprising:
a housing fitted with an inlet port extending to an inlet chamber and configured for coupling to an upstream liquid supply line, and an outlet port extending from an outlet chamber and configured for coupling to a downstream supply line;
a high flow-rate path fitted with a hydraulic faucet comprising a main diaphragm extending between the inlet chamber and the outlet chamber for selectively admitting liquid flow therebetween at substantially high flow rates;
a main chamber extending at one face of the main diaphragm and configured with a restricted flow path extending between an inlet chamber and the main chamber; and
a low flow-rate pressure regulating unit in flow communication with the outlet chamber and configured with a control chamber fitted with a control diaphragm having one face in normally open flow communication with the outlet chamber and at an opposite face thereof is vented to the atmosphere;
said control diaphragm is configured for controlling a pressure regulating flow path, and extends in flow communication between the main chamber and the outlet chamber.

50. A two stage flow control valve, comprising:
an inlet port and an outlet port;
a low-pressure regulating valve and an electric faucet extending in parallel flow relation to one another, each having an inlet being in flow communication with the inlet port and outlet being in flow communication with the outlet port; and
a flow sensor extending upstream of said outlet port or extending downstream of said inlet port and configured for generating a flow control signal responsive to fluid flow and transmitting said signal to said electric faucet.

51. The two stage flow control valve according to claim 50, wherein high flow rate through the flow sensor results in generating a control signal to open the electric faucet and low flow rate through flow sensor entails shutting said electric faucet and resulting in directing low flow through the low-pressure regulating valve.
